(19) United States
(12) Patent Application Publication
(10) Pub. No.: US 2005/0114374 A1
(43) Pub. Date: May 26, 2005

(54) User interface for a combination compact disc recorder and player system

(76) Inventors: Henry E. Juszkiewicz, Nashville, TN (US); Kris O. Carter, Washington, DC (US)

Correspondence Address: WADDEY & PATTERSON, 414 UNION STREET, SUITE 2020, BANK OF AMERICA PLAZA, NASHVILLE, TN, 37219, US

(21) Appl. No.: 11/026,475

(22) Filed: Dec. 30, 2004

Related U.S. Application Data
(63) Continuation-in-part of application No. 10/406,821, filed on Apr. 4, 2003.
(60) Provisional application No. 60/534,796, filed on Jan. 7, 2004.

(51) Int. Cl. G11B 19/00

(52) U.S. Cl. 707/101

(57) ABSTRACT

A user interface for a combination recorder and player system includes user interface software that is designed to generate and display a series of screens that allow a user to copy, burn, play, listen to, manage, and download music, and a touch sensitive display for displaying the screens generated by the user interface software. The touch sensitive display is also designed to receive commands input by a user and the user interface software is designed to process those commands and cause the combination recorder and player unit to copy, burn, play, manage, and download music.

### APPLICATION FOR UNITED STATES LETTERS PATENT

This application is a nonprovisional patent application claiming priority under 35 U.S.C. 119(e) on co-pending U.S. Provisional Patent Application Ser. No. 60/534,796 filed Jan. 7, 2004 and entitled “User Interface for a Combination Compact Disc Recorder and Player System,” which is hereby incorporated by reference.

This application is also a Continuation-in-part application claiming priority under 35 U.S.C. §120 on U.S. patent application Ser. No. 10/406,821 filed Apr. 4, 2003 and entitled “Combination Compact Disc Recorder and Player System,” which is hereby incorporated by reference.

Be it known that we, Henry E. Juszkiewicz, a citizen of the United States, residing in Nashville, Tenn., and Kris O. Carter, a citizen of the United States, residing in Washington, D.C., have invented a new and useful “User Interface for a Combination Compact Disc Recorder and Player System.”

### BACKGROUND OF THE INVENTION

The present invention relates generally to user interfaces for computer systems. More particularly, the present invention pertains to user interface software for a combination CD recorder and player system described in co-pendng U.S. patent application Ser. No. 10/406,821, filed Apr. 4, 2003 and entitled “Combination Compact Disc Recorder and Player System,” (the '821 application”).

The '821 application discloses a combination CD recorder and player system that includes a combination recorder and player unit and a remote control unit. The combination recorder and player unit is designed to allow a user to copy music from music CDs into the recorder and player unit, to burn music from the recorder and player unit onto blank CDs, and to download and store music from a music server. The recorder and player unit is also designed to allow a user to play and listen to music from music CDs, music stored on the recorder and player unit, and music downloaded from the music server but not stored on the recorder and player unit.

The remote control unit is designed to communicate with and control the recorder and player unit. To facilitate this function, the remote control unit includes a touch sensitive display and remote control software. As explained in the '821 application, the remote control software is designed to generate a series of screens or menus that allow a user to play, listen, copy, and burn music using the recorder and player unit. The touch sensitive display is used to display these screens to the user and to receive input commands from the user. The user inputs are processed by the remote control software and used to cause the recorder and player unit to perform its various functions.

Since the filing of the '821 application, the assignee of the '821 application has developed new remote control software that allows a user to perform all of the functions performed by the previous version of that software, as well as a variety of additional functions. The purpose of the present application, then, is to provide a detailed description of this new remote control software.

### SUMMARY OF THE INVENTION

The remote control software of the present invention, which shall be referred to hereinafter as user interface software, is designed to be used with the remote control unit and the recorder and player unit described in the '821 application discussed previously and to replace the remote control software described in that application. More specifically, the user interface software is designed to be used with the touch sensitive display included with the remote control unit. Collectively, the touch sensitive display, which displays the screens generated by the user interface software and receives input commands from a user, and the user interface software operate together to create a user interface for the combination recorder and player system described in the '821 application.

The user interface software is designed to generate screens that allow a user to copy music from music CDs to the recorder and player unit, to burn music stored on the recorder and player unit to blank CDs, and to copy music stored on the recorder and player unit to external devices. The user interface software is designed to allow a user to view, select, and listen to music stored on music CDs, music stored on the recorder and player unit, including individual songs, albums, and playlists, and channels of digital radio music downloaded from the music server discussed in the '821 application. The user interface software is also designed to allow a user to create, edit, and remove music playlists using music stored on the recorder and player unit and to view, select, purchase, and download music from the music server described in the '821 application.

### BRIEF DESCRIPTION OF THE DRAWINGS

FIG. 1 is a block diagram showing one embodiment of a combination recorder and player unit including the user interface software of the present invention.

FIGS. 2-74 are printouts of screens generated by the user interface software of the present invention.

FIG. 75 is a block diagram showing four event driven flows implemented using the user interface software of the present invention.

FIGS. 76-88 are printouts of screens generated by the user interface software of the present invention that allow a user to adjust system preferences for the present invention.

FIGS. 89-93 are printouts of screens generated by the user interface software that illustrate various features of the present invention.

FIG. 95 is a flow diagram illustrating the device connection synchronization process of the present invention.

FIG. 96 is a printout of a screen generated by the present invention that allows a user to edit the name of and remove a device.

FIGS. 96-98 are flow diagrams showing the ripping process of the present invention.

FIGS. 99-100 are flow diagrams showing the burning process of the present invention.

FIGS. 101-104 are flow diagrams showing alternative versions of the ripping and burning processes of the present invention.

FIG. 105 is a flow diagram showing the playlist creation process of the present invention.

FIGS. 106-107 are flow diagrams showing the device synchronization process of the present invention.

FIGS. 108-109 are flow diagrams showing the album synchronization process of the present invention.

FIG. 110 is a flow diagram showing the playlist synchronization process of the present invention.

FIGS. 111-112 are flow diagrams showing the sorting and view changing processes of the present invention.

FIGS. 113-115 show three alternative embodiments of the present invention.

### DESCRIPTION OF THE PREFERRED EMBODIMENTS

The user interface software of the present invention is designed to be used with the combination recorder and player system described in co-pending U.S. patent application Ser. No. 10/406,821, filed Apr. 4, 2003 and entitled “Combination Compact Disc Recorder and Player System” (“the '821 application”). As explained in detail in the '821 application, the combination recorder and player system includes a combination recorder and player unit that can be used to copy, listen to, manage, and download music, and a remote control unit that can be used to control the combination recorder and player unit. The remote control unit includes remote control software that allows the remote control unit to be used to control the combination recorder and player unit and the user interface software of the present invention is designed to replace that software. Detailed information regarding the structure and operation of both of these units is included in the '821 application and that information is incorporated by reference into the present application.

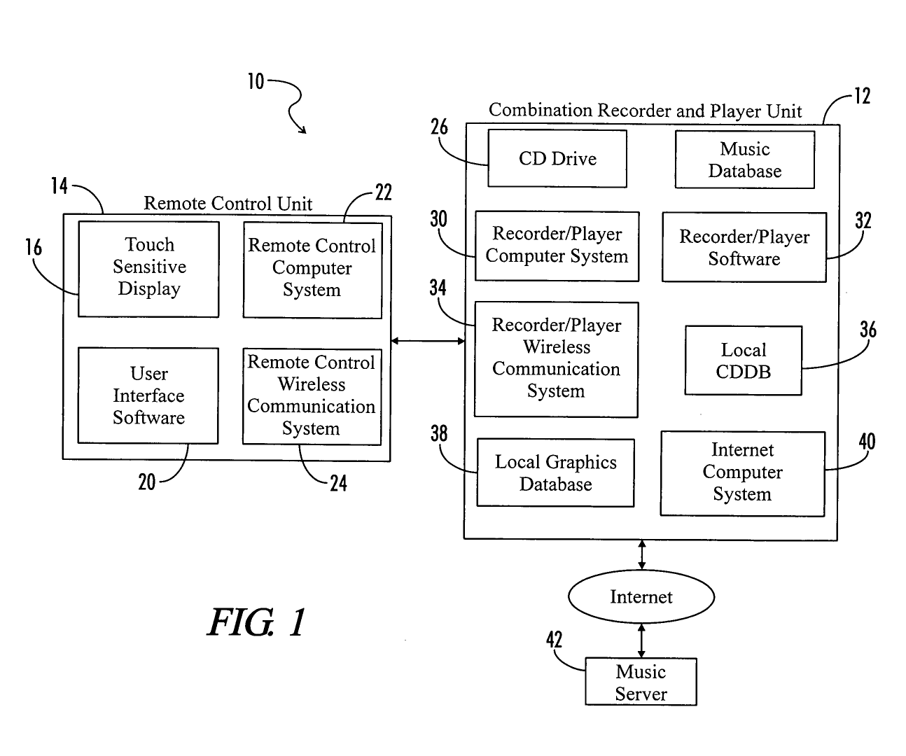

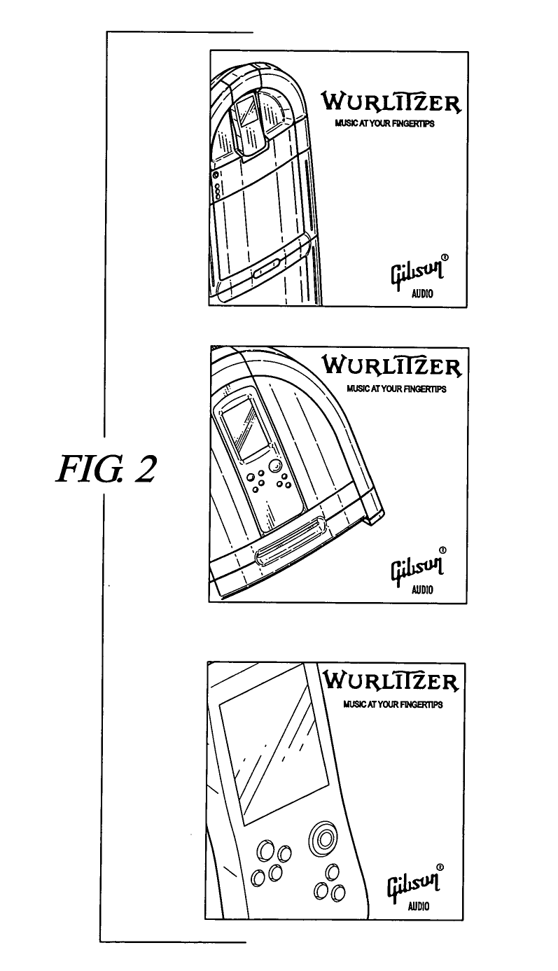

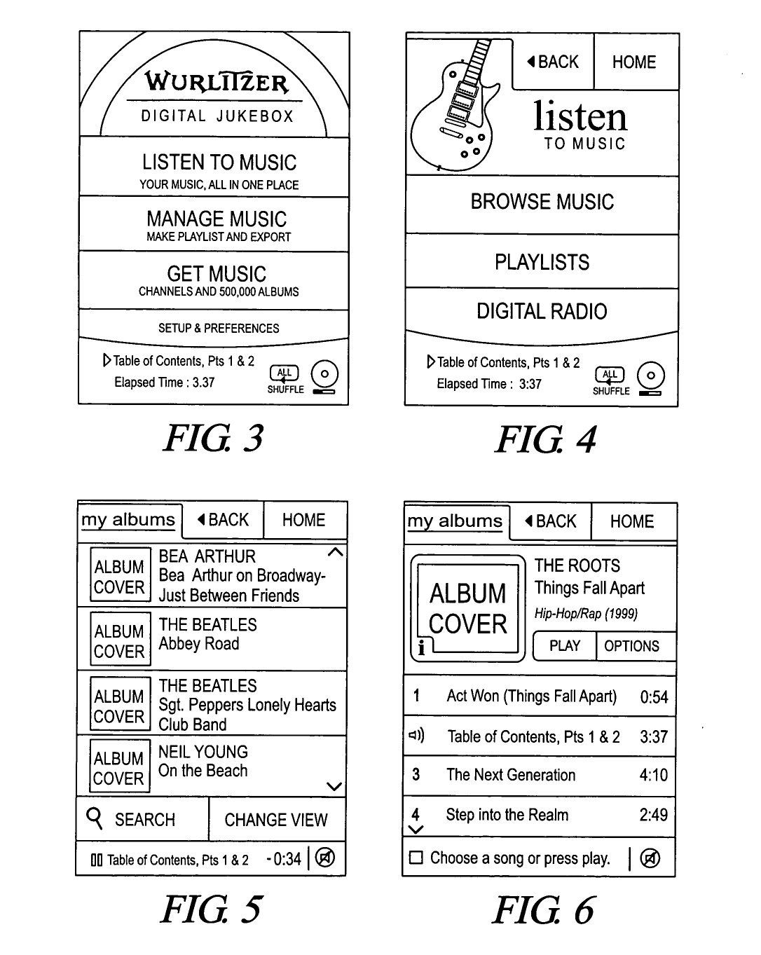

FIG. 1 is a block diagram showing one embodiment of the combination recorder and player system 10 of the '821 application including the combination recorder and player unit 12 and the remote control unit 14. As shown in that figure, the remote control unit 14 includes a touch sensitive display 16, the user interface software 20 of the present invention, a remote control computer system 22, and a remote control communication system 24. The combination recorder and player unit 12 includes a CD drive 26, a music database 28, a recorder/player computer system 30, recorder/player software 32, a recorder/player communication system 34, a local compact disc database (CDDB) 36, a local graphics database 38, and a recorder/player Internet communication system 40. The touch sensitive display 16, the remote control computer system 22, the remote control communication system 24, the CD drive 26, the recorder/player computer system 30, the recorder/player software 32, the recorder/player communication system 34, and the recorder/player Internet communication system 40 are all identical to their corresponding components shown in FIGS. 2 and 3 of the '821 application. The music database 28, the local CDDB 36, and the local graphics database 38 are all included in recorder/player memory (not shown) that is identical to the recorder/player memory 24 shown in FIG. 2 and described in the '821 application.

The user interface software 20 (“the UI software 20”) of present invention is designed to allow a user to use the combination recorder and player unit 12 to copy, listen to, manage, and download music. The UI software 20 accomplishes this function by causing the remote control unit 14 to generate and display screens of information for the user using the touch screen display 16, to receive user commands input by a user using the touch screen display 16, and, in response to the user commands, to generate and send commands to the combination recorder and player unit 12 that cause it to perform its various functions.

The information displayed by the UI software 20 includes information regarding music stored on the combination recorder and player unit 12, music available from a music server computer system 42 (see FIG. 1), and status information regarding the combination recorder and player unit 12 itself. The music server computer system 42 is identical to the music server computer system 100 shown in FIG. 6 and described in detail in the '821 application and described in co-pending U.S. patent application Ser. No. 10/407,811, filed Apr. 4, 2003 and entitled “Music Distribution System” (“the '811 application”). The '811 application is incorporated by reference into the present application.

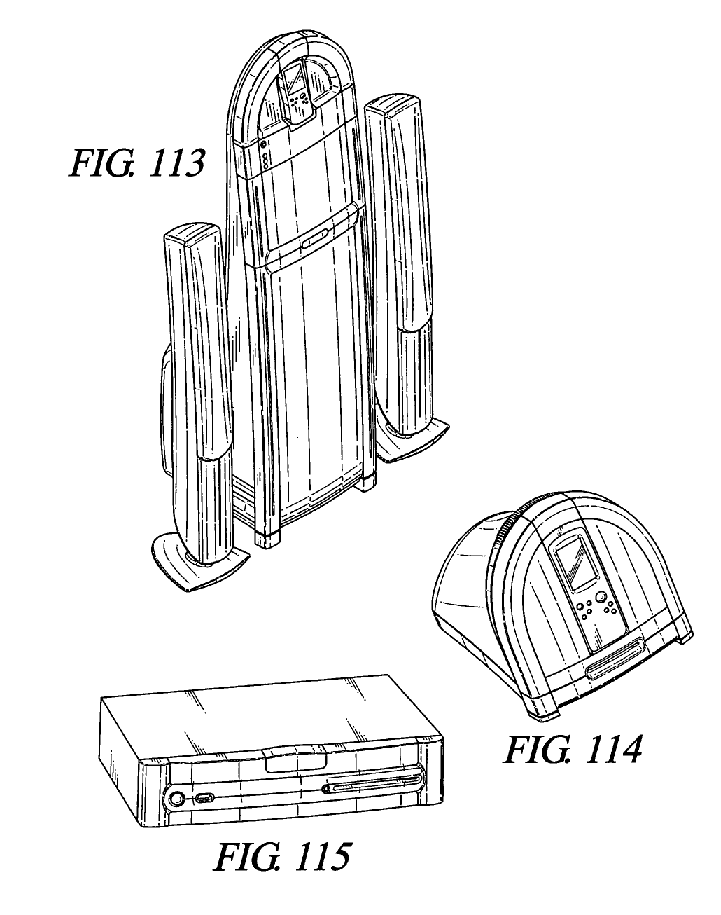

The assignee of the present invention has developed two alternative versions of the present invention: a floor standing model and a component model. These versions are illustrated in FIGS. 113-114, respectively.

The first screen generated by the UI software 20 of the present invention is a splash screen that indicates that the software was created by the assignee of the present application, Gibson Guitar Corporation. Three examples of that screen are shown in FIG. 2.

The next screen generated by the UI software 20 is the Main Menu screen. This screen is used by a user to listen to, manage, and download music using the combination recorder and player unit 12. This screen also allows a user to adjust the setup and preferences for the combination recorder and player system. An example of this screen is shown in FIG. 3. The small disc in the lower right hand corner of this figure indicates that a CD is currently being played by the combination recorder and player unit 12.

When a user selects the “Listen to music” button, the UI software 20 causes the remote control unit 14 to generate and display a “Listen to music” main screen. This screen is used to listen to music stored on the combination recorder and player unit 12, to listen to playlists stored on the combination recorder and player unit 12, and to listen to digital radio channels received from the music server 42. The “Listen to music” screen is shown in FIG. 4.

From the “Listen to music” main screen, a user can view music stored on the combination recorder and player unit by selecting the “Browse music” button. When a user does so, the UI software 20 causes the remote control unit 14 to generate and display an “Album view” screen (see FIG. 5) that includes a listing of albums stored on the combination recorder and player unit 12. This view is the default setting for viewing music stored on the combination recorder and player unit 12 and includes album graphics for each album, the title of each album, and the artist or artists associated with each album.

As shown in FIG. 5, the “Album view” screen includes “Back” and “Home” buttons that may be selected by a user. If a user selects the “Back” button, the UI software 20 generates the screen that was being displayed immediately before the “Album view” screen was displayed. If a user selects the “Home” button, the UI software 20 redisplays the Main Menu screen shown in FIG. 3.

The UI software 20 allows a user to scroll through albums stored on the combination recorder and player unit 12 using a scroll bar included on the right-hand side of the screen shown in FIG. 5. As discussed in more detail below, the UI software 20 also allows a user to search through the albums or to change the album view to a song view by simply clicking on the “Search” and “Change view” buttons on the “Album view” screen.

FIG. 6 is a screen generated by the UI software 20 in response to a user clicking on a specific album and is referred to as the “Album detail” screen. In this screen, a user can review all of the songs included on an album, can select and play a song from an album by selecting one of the listed songs, and can play the album by clicking on the “Play” button. A user can also obtain additional information regarding an artist by clicking on the small “i” icon shown in FIG. 6. If a user clicks on this icon, the UI software 20 generates the screens shown in FIGS. 91 and 92. By clicking on the “Options” button, a user can also edit the name of an album, the artist associated with an album, or remove an album from the combination recorder and player unit 12. The screens generated by the UI software 20 that allow a user to perform these functions are shown in FIGS. 7-10. The rows of blocks included in FIGS. 8 and 9 are generic representations of keyboard elements that will be shown and discussed in more detail in a later screen.

The UI software 20 can be used to search through the albums stored in the combination recorder and player unit 12 by artist name, album title, and genre. A generic version of the screen generated by the UI software 20 for this purpose is shown in FIG. 11. When a user clicks on the “Artist Name” button shown in that figure, the UI software 20 generates and displays a screen (see FIG. 12) that includes buttons representing the keys typically found on a computer keyboard and a prompt for the user to enter an artist's name. In response to a user doing so, the UI software 20 generates a screen that indicates the number of albums that have been found during a search based on the entered letters. That screen is shown in FIG. 13. Numbers and symbols can be entered by clicking on the “Num/Sym” button shown in FIG. 12 and using the resulting screen shown in FIG. 14.

To see the results of a search, a user clicks on the “See results” button shown in FIG. 12 and the UI software 20 generates a screen showing the search results. An example of a results screen generated by the UI software 20 of the present invention is shown in FIG. 15. From this screen, a user can click on the “Clear search” button and return to the screen that was being displayed before the search was initiated, click on the “Search again” button to perform another search, or click on the “Change view” button to view the songs included in the albums returned by the search.

Screens similar to the screens shown in FIGS. 12-15 are also generated by the UI software 20 when a user performs a search based on album title by clicking on the “Artist title” button shown in FIG. 11.

When a user searches through albums based on genre, a slightly different set of screens are generated by the UI software 20. As shown in FIGS. 16 and 17, the UI software 20 generates a listing of genres for the user to choose from (FIG. 16) and, when the user selects one of the listed genres, the UI software 20 generates a search results screen (FIG. 17) that includes a listing of all albums stored in the combination recorder and player unit 12 that fall within the selected genre. As was the case with the artist name and title searches discussed previously, the user can clear the genre search results screen, perform another genre search, or change the view of the genre search results from album view to song view by clicking on the appropriate buttons in FIG. 17.

Referring back to FIG. 5, when a user clicks on the “Change view” button, the UI software 20 generates the “Change view” screen shown in FIG. 18. This screen is used by a user to change the “Album view” screen shown in FIG. 5 to the “Song view” screen shown in FIG. 19. The “Song view” screen includes a listing of all songs stored on the combination recorder and player unit 12 and a user can scroll through this listing in the same manner that they can scroll through the listing of albums in the “Album view” screen. Also, each song in the listing includes a small graphic of the album cover of the album associated with that song.

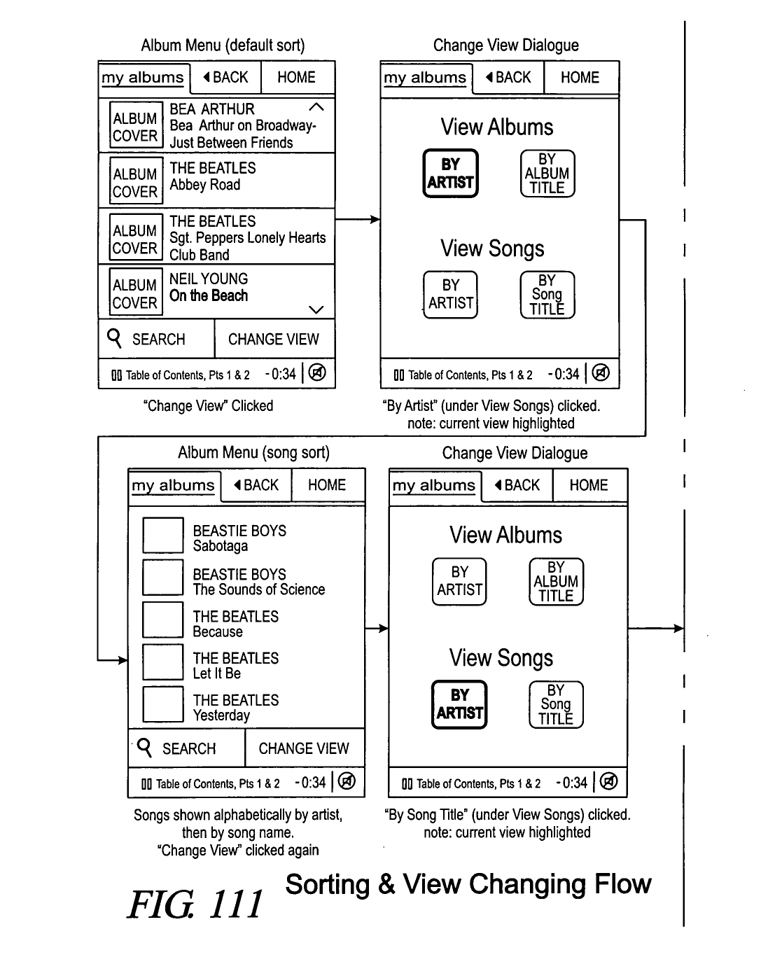

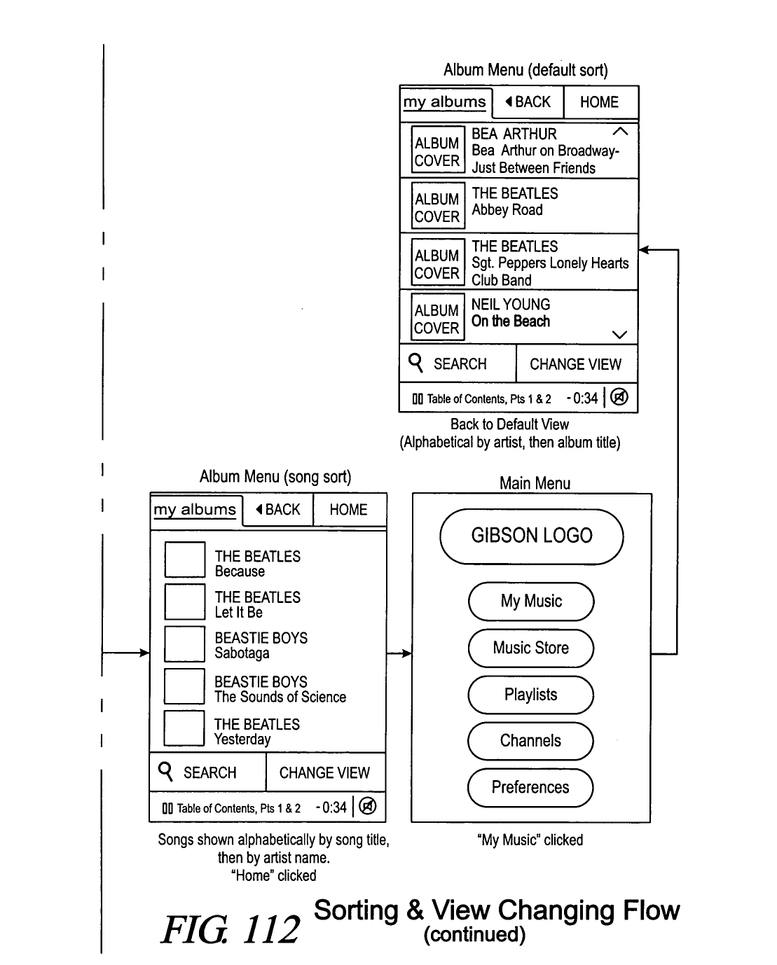

In addition to changing from an album view to a song view, albums and songs displayed by the UI software 20 can be sorted according to artist name, album title, and song title. FIGS. 111-112 illustrate the process of sorting and changing the views of music that can be implemented by a user using the UI software 20.

When playing the songs included in an album, the UI software 20 allows a user to shuffle those songs so they are played randomly, to repeat the playing of one or all of those songs, or both. The screen generated by the UI software 20 that allows a user to select these options is shown in FIG. 20. If a user selects any of these options, indicators appear on the “Album detail” screen to indicate that fact. FIG. 21 includes an indicator showing that none of these options have been selected (screen includes the word “off” highlighted), FIG. 22, includes an indicator showing that the repeating of 1 song has been selected (screen includes highlighted “1” where the word “off” was previously located), and FIG. 23 includes an indicator showing that the repeating and shuffling of all songs has been selected (screen includes highlighted “All” and “Shuffle” indicators).

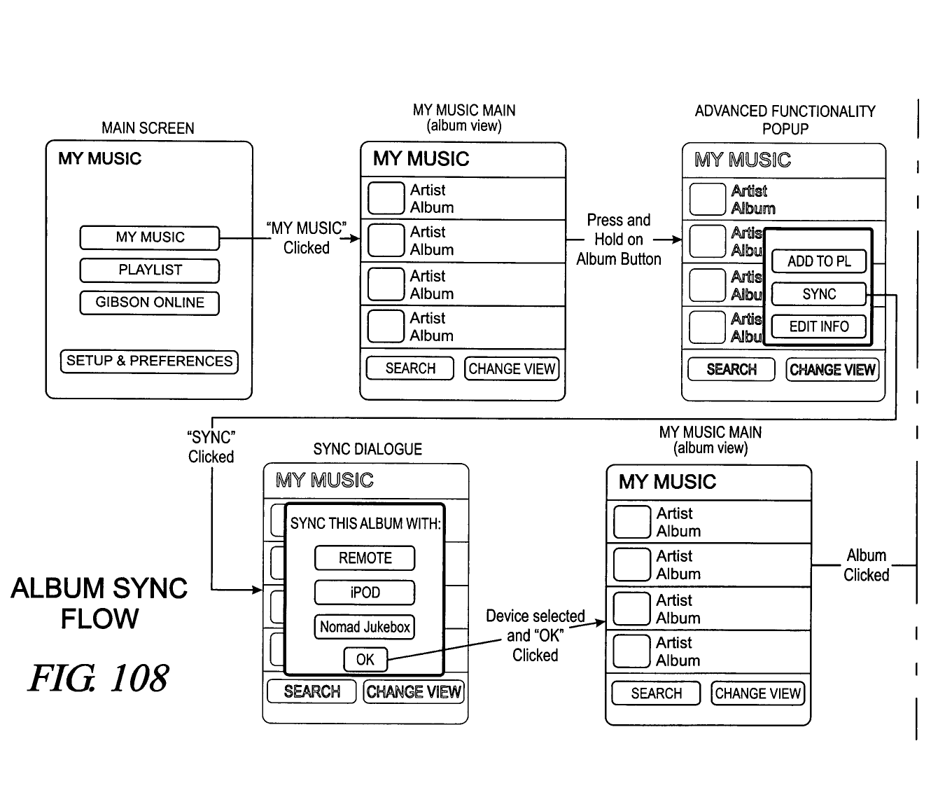

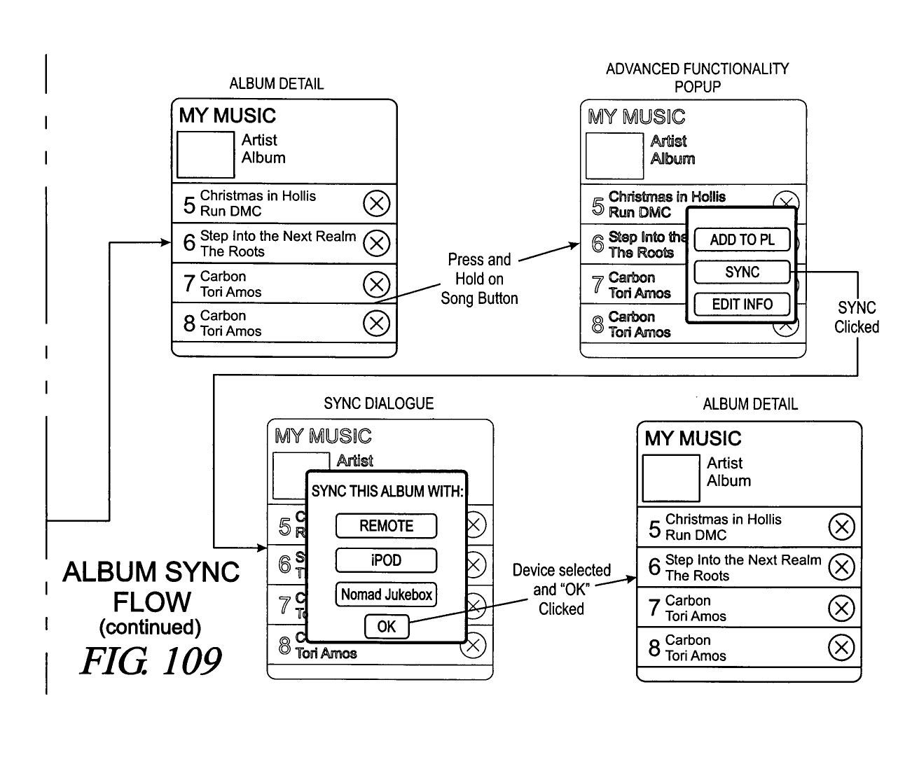

The UI software 20 also includes advanced functionality that makes it easier to perform editing and syncing functions. When a user presses and holds an album button in the “Album view” screen, the UI software 20 generates a “popup” balloon (FIG. 24) that allows a user to synchronize the storage of an album so that it is stored on the combination recorder and player unit 12 in the same manner that it is stored on another device, such as the remote control unit 14. The synchronization of an album is illustrated in FIGS. 108 and 109. As shown in FIG. 24, the “popup” balloon also allows a user to edit the name of an album, to edit the artist name associated with an album, or to remove an album from the combination recorder and player unit 12.

Similar advanced functionality is also provided for the “Album detail view” screen (FIG. 25) and the “Song view” screen (FIG. 26). In addition to allowing a user to synchronize, edit and remove a song, the “popup” balloons for these screens also allows a user to add a song to a play list of songs. The playing, creating, and editing of play lists will be discussed in more detail below.

Referring to FIG. 27, the UI software 20 allows a user to adjust the volume and to mute the playing of a song using the combination recorder and player unit 12.

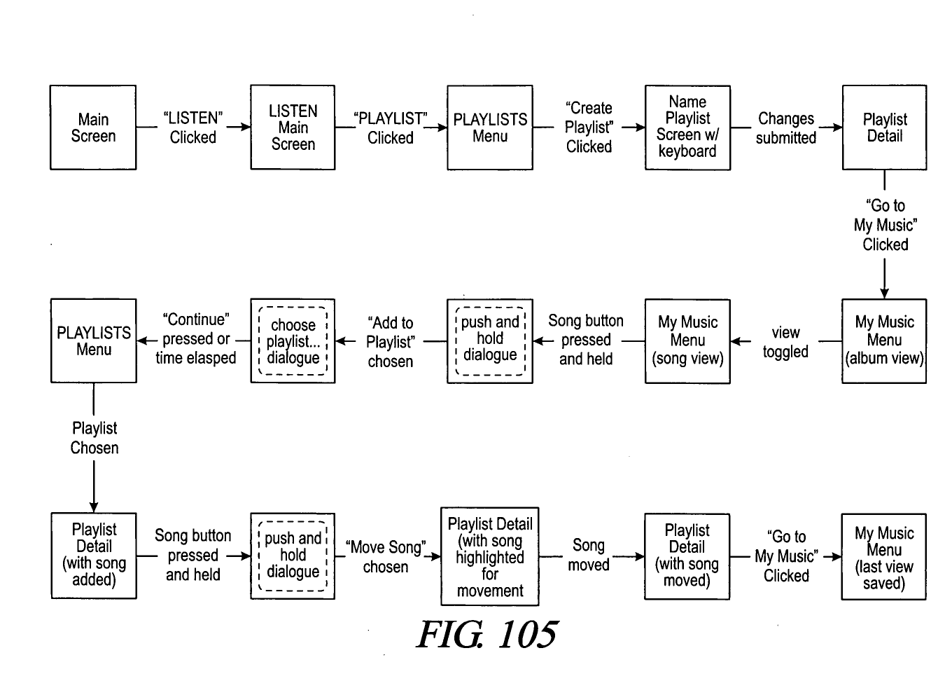

When a user clicks on the “Playlists” button shown in FIG. 4, the UI software 20 of the present invention causes the remote control unit 14 to generate and display a listing of music play lists stored on the combination recorder and player unit 12. A generic example of such a screen, referred to as a “Playlist view” screen, is shown in FIG. 28. If a user selects one of the play lists shown in that figure, the UI software 20 generates a “Playlist detail” screen (FIG. 29) that includes a listing of all of the songs included in the selected play list. A user plays a song in a play list by simply clicking on that song. A user creates a playlist by clicking on the “Create playlist” button. An example of the process for creating a playlist is illustrated in FIG. 105.

The “Playlist detail” screen is very similar to the “Album detail” screen and includes “Play”, “Options”, “Back”, and “Home” buttons that operate in the same manner as the ones included on the “Album detail view” screen. The “Playlists detail” screen also includes “Edit” buttons by each of the songs included in the play list. By clicking and holding on one of these “Edit” buttons, a user is able to move a song up or down in the play list and thereby change its playing order, or remove a song from the play list. A screen generated by the UI software 20 when an “Edit” button has been clicked and held is shown in FIG. 30.

The UI software 20 allows a user to add music to a play list, edit the name of a play list, and delete a play list by clicking on the “Options” button shown in FIG. 29. The screen generated as a result of a user clicking that button is shown in FIG. 31.

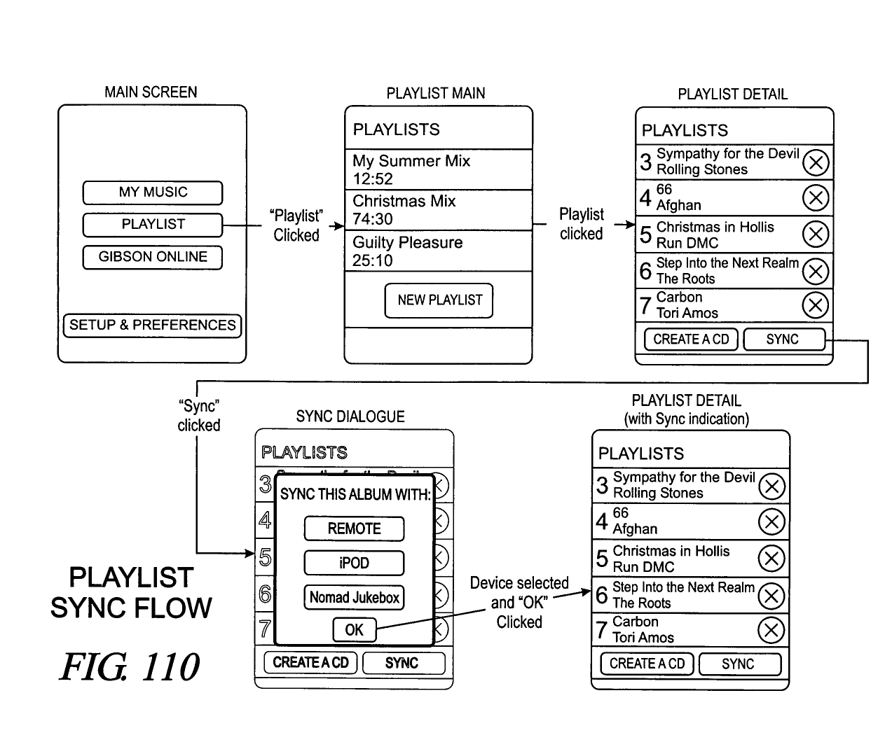

Referring to FIGS. 32 and 33, the UI software 20 includes advanced functionality for the play lists screens that allows a user to more easily perform several functions. For example, by pressing and holding down on a play list in the “Playlist view” screen, the UI software 20 generates a “popup” balloon that allows a user to synchronize the play list on the combination recorder and player unit 12 and another device, to add a song to the play list, and to remove the play list. The playlist synchronization flow is illustrated in FIG. 110. If a user presses and holds down a song in the “Playlist detail view” screen, the UI software 20 generates a “popup” balloon that allows a user to move the song within the play list, to remove the song from the play list, and to add songs to the play list.

FIG. 34 is a “Digital radio” screen generated by the UI software 20 when a user clicks on the “Digital Radio” button shown in FIG. 4. This screen includes a listing a digital radio channels that are available from the music server 42 shown in FIG. 1 and that can be listened to by a user who has subscribed to Gibson's digital radio service. The Gibson digital radio service is described in detail in the '821 and '811 applications discussed previously. If a user clicks on the “Digital Radio” button and he or she is not a subscriber, the UI software 20 displays a screen indicating that fact and prompting the user to subscribe to the service. An example of that screen is shown in FIG. 35.

The “Digital radio” screen includes “Back” and “Home” buttons that cause the UI software 20 to go back one screen or to the Main Menu screen, respectively, when clicked. The “Digital radio” screen also includes a “Search” button, which allows a user to search through the channels of digital radio to locate a desired channel, and a “Music store” button, which allows a user to purchase and download songs and albums from the music server 42. To allow a user to search through the digital channels, the UI software 20 generates a series of screens that are very similar to the screens that allow a user to search through albums stored on the combination recorder and player unit 12 and shown in FIGS. 11-17.

When a user clicks on a digital radio channel, the UI software 20 generates a displays a “Digital radio detail” screen that includes a description of the music and includes a graphic of the album currently being played. An example of this type of screen is shown in FIG. 36. To listen to a digital radio channel, a user simply clicks on the “Listen now” button. To purchase an album being played, a user simply clicks on the “Buy album” button, and to buy a song being played, a user simply clicks on that song in the detail channel listing.

Referring to FIG. 37, the UI software 20 allows a user to manage music in two different ways. First, the UI software 20 allows a user to manage playlists that are stored on the combination recorder and player unit 12 by clicking on the “Playlists” button. Second, the UI software 20 allows a user to manage music that is stored on external devices, such as the remote control unit 14, iPods, or other combination recorder and player units, by clicking on the “My devices” button.

When a user clicks on the “Playlists” button, the UI software 20 generates the “Manage playlists” screen shown in FIG. 38. If a user clicks on the “Create new playlist” button, the UI software 20 generates the “Name your playlist” screen shown in FIG. 39, and, if a user clicks on the “Continue” button in the “Name your playlist” after typing in a name for the new playlist, the UI software 20 generates the empty playlist screen shown in FIG. 40. Note that the blocks shown in FIG. 39 are generic representations of the keyboard keys described earlier and shown in FIG. 12.

When a user clicks on the “Add songs from my music” button in the empty playlist screen, the UI software 20 generates the “Add songs information” screen shown in FIG. 41. The “Add songs information” screen in FIG. 41 is also generated when a user clicks on one of the playlists shown in FIG. 38, which results in the generation of the “Playlist detail” screen shown in FIG. 42, and a user clicks on the “Add songs from my music” button in that screen. Regardless of how the “Add songs information” screen is generated, a user must click on the “Continue” button in that screen in order to add songs to a Playlist.

When a user clicks on the “Continue” button, the UI software 20 generates the screens shown in FIGS. 43-48. First, the UI software 20 generates the “Manage playlists album view” shown in FIG. 43. When a user selects an album from that screen, the UI software 20 generates the “Manage playlists album detail view” shown in FIG. 44. When a user selects a song from the listing of songs included in the “Manage playlists album detail view,” the UI software 20 generates the “Where should this song do dialogue” shown in FIG. 45. This screen gives a user three options. The user can simply add the song to the playlist that the user originally selected when the manage playlist process was initiated by clicking on the “Just add” button, in which case the UI software 20 adds the song to that playlist and then redisplays the “Manage playlists album detail view” (see FIG. 46) so the user can add another song. The user can also add the song and go to that playlist by clicking on the “Add and go” button. In this case, the UI software 20 adds the songs and redisplays the “Playlist detail” screen (FIG. 47). Once back on this screen, the user can click and hold on a song, placing the screen in a “super edit” mode, and can move the song up and down in the Playlist (FIG. 48). Finally, the user can choose to add the song to another Playlist instead of the playlist that the user originally selected when the manage Playlist process was initiated.

The UI software 20 generates the “My devices detail” screen, shown in FIG. 49, when a user clicks on the “My devices” button shown in FIG. 37. This screen contains a listing of all of the external devices that have been added by a user and that can store music from the combination recorder and player unit 12. As shown in FIG. 49, a user can remove a device by clicking the “Remove” button, in which case the UI software 20 will generate a screen that prompts the user to confirm that they want to remove the device (FIG. 50), and can add another device by clicking on the “Add another device” button. When the user clicks on the “Add another device” button, the UI software 20 generates a screen that allows the user to type the name of the new device (FIG. 51), and, when the user clicks the “Continue” button on that screen, redisplays the “My devices detail” screen with the new device added. If the user types in a name that is already associated with a device, the UI software 20 redisplays the “My devices detail” screen with the named device included on the screen.

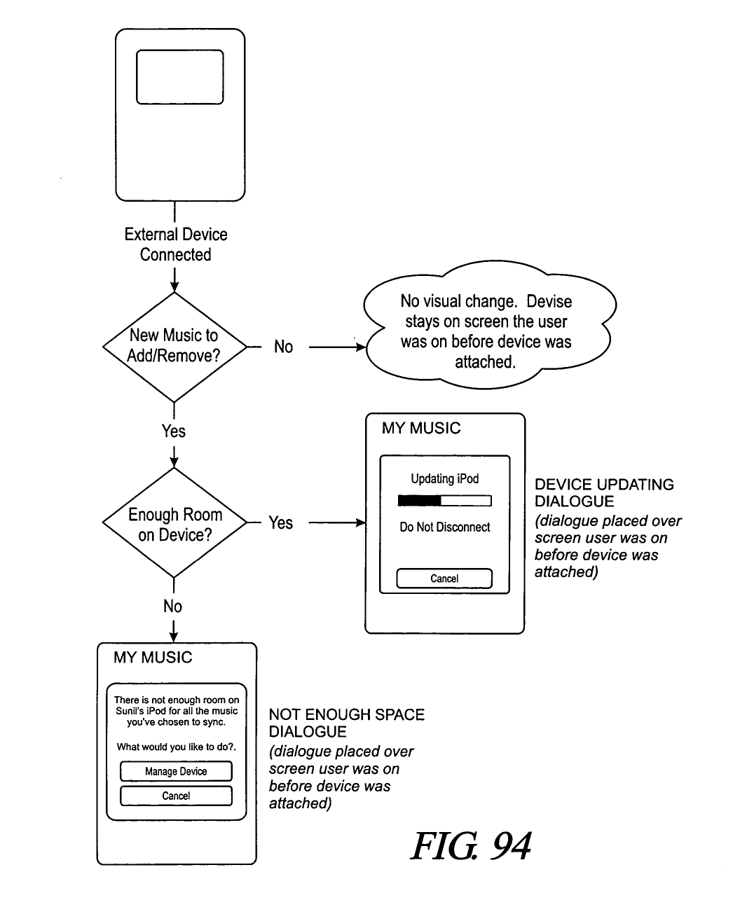

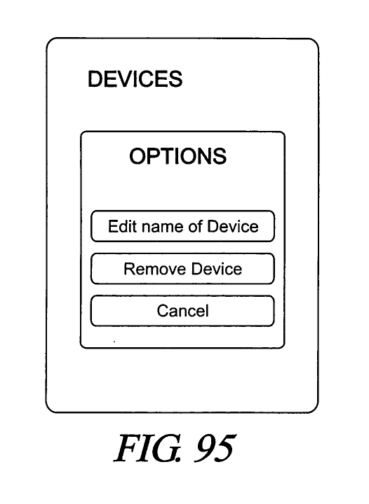

If a user clicks on one of the devices included in the “My devices detail” screen, the UI software 20 generates a “Device detail” screen for the selected device that includes a listing of all music, including playlists, songs, or albums, that are recorded on that device. An example of that type of screen is shown in FIG. 52. The “Device detail” screen includes information regarding the number of songs on the device, the amount of memory that is used up by those songs and the memory that is remaining on the device. This screen also includes an “Options” button, which when selected causes the UI software 20 to generate a screen (FIG. 95) that can be used by the user to edit the name of a device and to remove a device, and “Remove” buttons for each song, album, or playlist stored on the device that allow a user to remove a song, album, or playlist stored on the device.

The “Device detail” screen also includes an “Add more music” button that can be used to add music to a device. When a user clicks this button, the UI software 20 generates an “Add song to device information” screen (FIG. 53) that indicates that a user can add a song or playlist by simply clicking on a song or playlist, and that an album can be added by clicking and holding an album button. When a user clicks on the “Continue” button in this screen, the UI software 20 redisplays the “Listen to music” screen shown in FIG. 4.

To add an album or a song from an album, a user clicks on the “My music” button in the “Listen to music” screen and the UI software 20 displays the “Album view” screen shown in FIG. 5. If the user clicks and holds on an album shown in that screen, the UI software 20 generates a screen that prompts the user to indicate the device that should receive the album. That screen is shown in FIG. 54.

As shown in FIG. 54, a user has three options with regard to where an album should be copied. The first option is to copy the album to the device that the user originally selected when the manage device process was initiated by clicking on the “Just add” button. If the user chooses this option, the UI software 20 adds the album to the device and then redisplays the “Album view” screen so the user can add another album. The user can also add the album and go to the device by clicking on the “Add and go” button. In this case, the UI software 20 adds the album and redisplays the “Device detail” screen shown in FIG. 52. Finally, the user can choose to add the album to another device instead of the device that the user originally selected when the manage device process was initiated.

To add a song from an album, the user clicks on an album in the “Album view” screen in FIG. 5, which causes the UI software 20 to display the “Album detail” screen shown in FIG. 6, and then clicks on the song to be added. When the user clicks on a song to be added, the UI software 20 generates a screen that prompts the user to indicate the device that should receive the song. This screen is shown in FIG. 55. As was the case with the screen shown in FIG. 54, the user has three options with regard to where the song should be copied. These options are identical to the options discussed above with regard to FIG. 54. In other words, the song can be copied to the device selected by the user when the manage device process was initiated and the “Album detail” screen is redisplayed, the song can be copied and the “Device detail”, including the copied song, can be displayed, or the song can be copied to another device.

Playlists are added to the device in a similar manner. To add a playlist, a user clicks on the “Playlists” button (FIG. 4) in the “Listen to music” screen and the UI software 20 displays the “Playlist view” screen shown in FIG. 28. If the user clicks on a Playlist shown in that screen, the UI software 20 generates a screen that prompts the user to indicate the device that should receive the Playlist (see FIG. 56). From that screen, the user can add the playlist by clicking on the “Just add”, “Add and go”, or “Choose another device” as explained in detail above with regard to songs.

Referring back to FIG. 3, the UI software 20 of the present invention can also be used to purchase and download music to the combination recorder and player unit 12 by clicking on the “Get Music” button shown in that figure. When a user clicks on that button, the UI software 20 causes the remote control unit to generate a “Get music” screen (see FIG. 57 and an alternative version shown in FIG. 89) that includes a feature area showing a featured music product, such as the Beatles complete collection, and that includes “Featured music”, “Browse by genre”, and “Search by artist, album, or song” buttons. If a user clicks on the “Featured music” button, the UI software 20 generates a “Featured music detail” screen containing a listing of featured music. An example of such a screen is shown in FIG. 58.

If a user clicks on the “Browse by genre” button, the UI software 20 generates a “Get music genre” screen (FIG. 59) that includes a listing of genres that the user can select from. If the user selects a genre from this listing, the UI software 20 generates a “Genre detail” screen (FIG. 60) that includes a “Featured music” button and a “Browse genre artist” button. If the user clicks on the “Featured music” button, the UI software 20 generates a screen showing a listing of featured music in the selected genre (FIG. 61) and, if the user clicks on the “Browse genre artist” button, the UI software 20 generates a screen containing a listing of artists in the selected genre (FIG. 62).

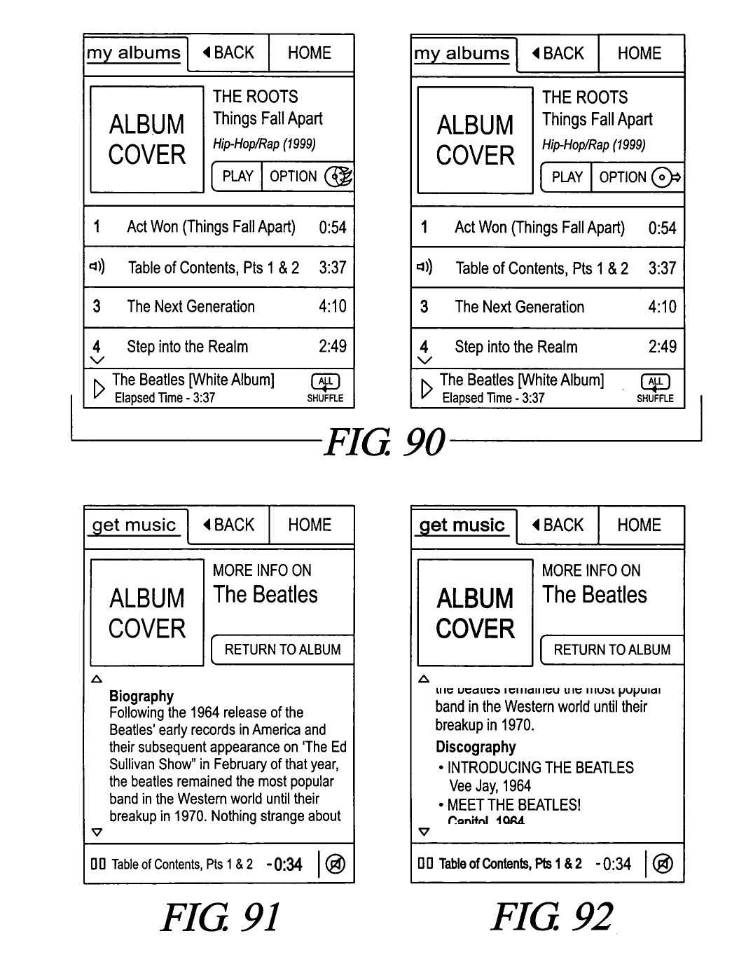

Selection of an artist from the list shown in FIG. 62 causes the UI software 20 to generate a screen that includes a listing of albums by that artist (FIG. 63) and the selection of an album from that listing causes the UI software 20 to generate a “Purchase album or song” screen that can be used by the user to purchase the album or a song from that album. An example of the “Purchase album or song” screen is shown in FIG. 64. This screen includes a status portion (not shown in FIG. 64, but see lower portion of each screen shown in FIG. 90) located in the lower portion of the screen that displays information regarding a song that is being played and indicating whether a music CD is being ripped or burned. The song information scrolls up in the following order: artist, song name, and album title. If any of these items is too long horizontally, they will scroll from left to right until the entire string is shown. Song information also includes the elapsed and the remaining playing time. Each of these items is displayed for approximately 5 seconds before switching to the other item.

If a burn or rip is in progress, an icon indicating that fact will pop up in place of the shuffle/repeat items, which will temporality move to the left (see lower right hand portion of screen in FIG. 21). The status bar at the bottom of the screen is broken into 15 pieces, each one pixel wide. When the rip or burn is complete, the status information will disappear and the shuffle/repeat items will move back to there normal position.

If the user clicks on a song in this screen, the UI software 20 plays a sample of the song (see FIG. 65) and, if a user clicks on the “Buy this album” or one of the “Buy song” buttons, the UI software 20 causes the music server 42 to download the selected album or song to the combination recorder and player unit 12. The screens generated during this process are shown in FIG. 66, which is a confirmation screen confirming the purchase, and FIG. 67, which is a download progress screen showing the progress of the download.

FIG. 68 is a “Search” screen generated by the UI software 20 that is used to search through music available on the music server 42 by artist name, album title, and song title. When a user clicks on the “Artist name” and “Album title” buttons in this screen, the UI software 20 generates the search input screens shown in FIGS. 69 and 70. When a user clicks on the “See results” screen in either of these two screens, the UI software 20 generates the same search results screen, which is shown in FIG. 71. When a user clicks on the “Song title” button in the “Search” screen shown in FIG. 68, the UI software 20 generates the search input screen shown in FIG. 72 and, when the user clicks on the “See results” button in that screen, it generates the search results screen shown in FIG. 73.

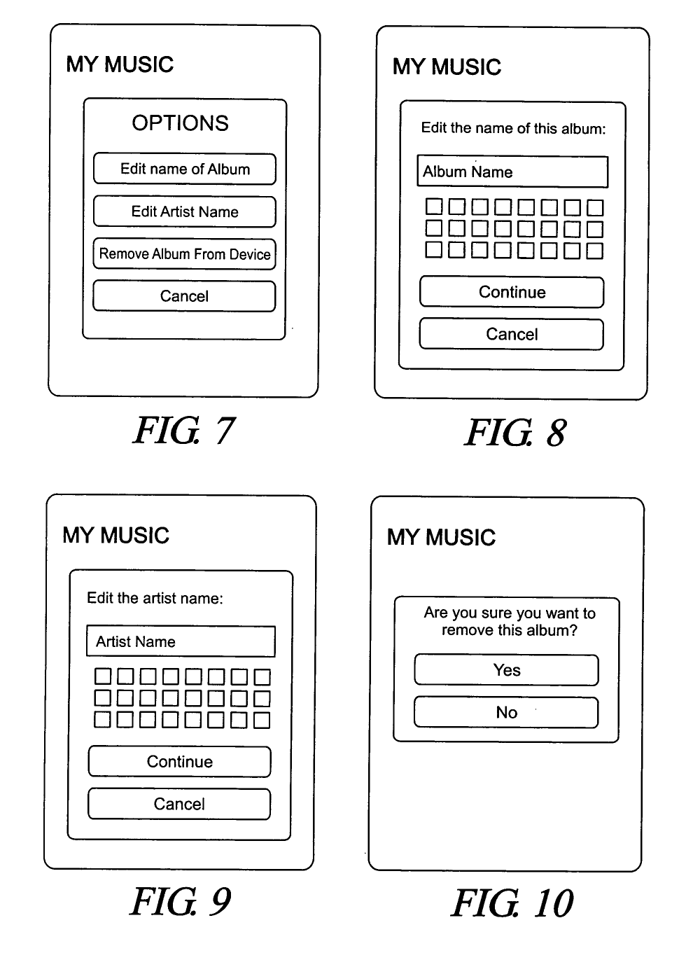

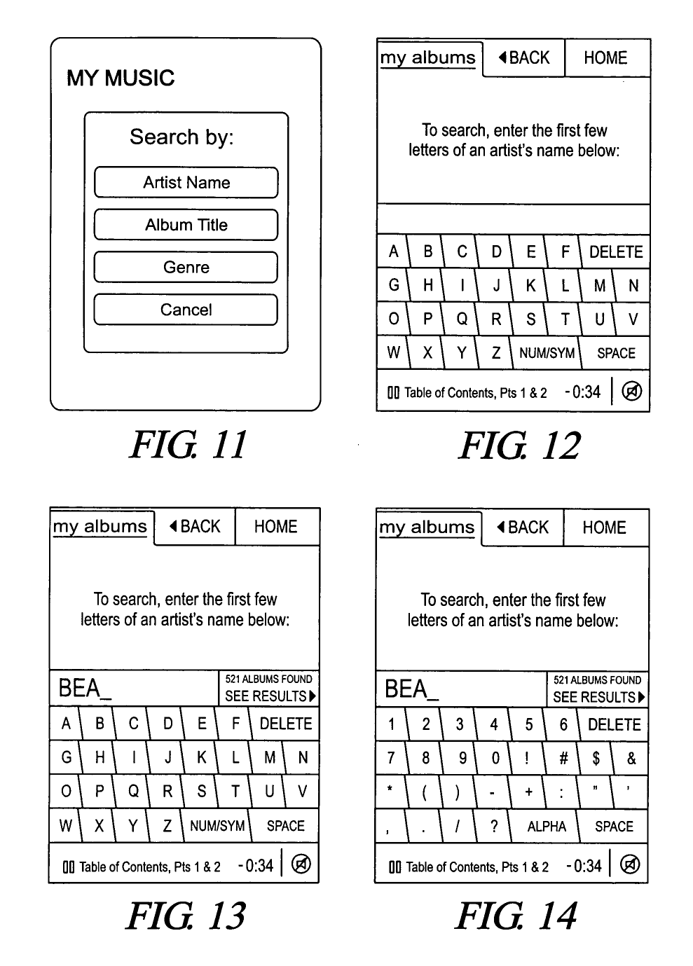

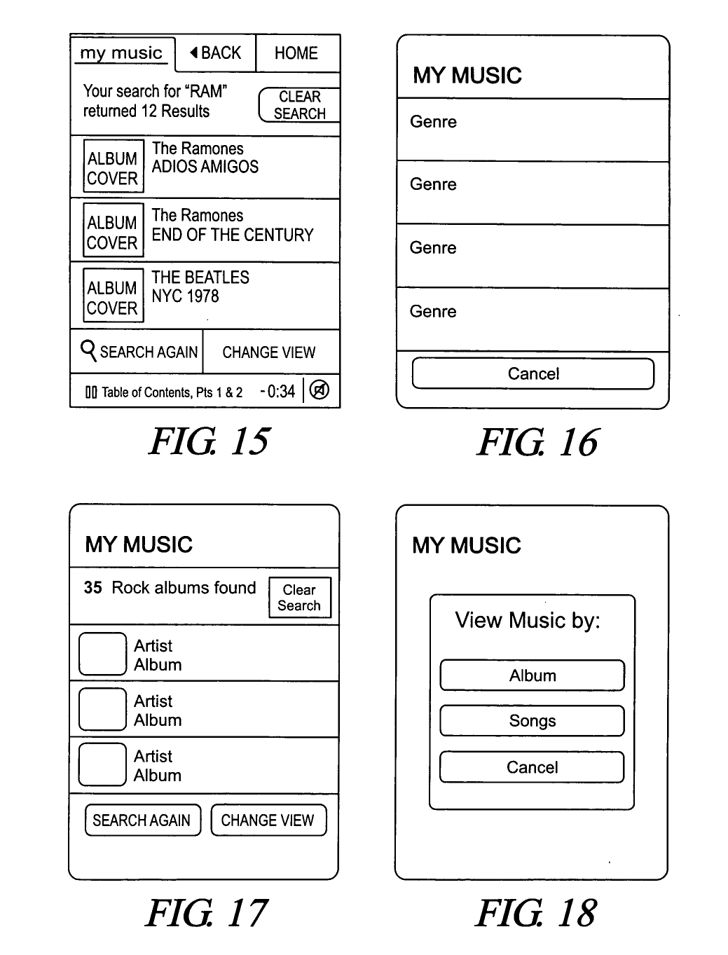

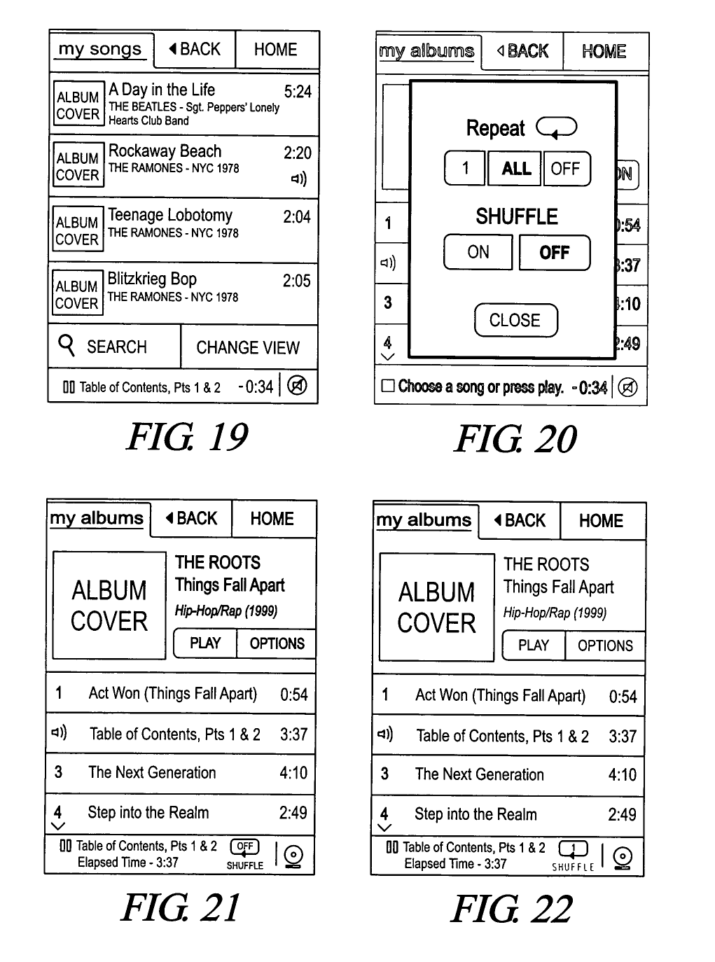

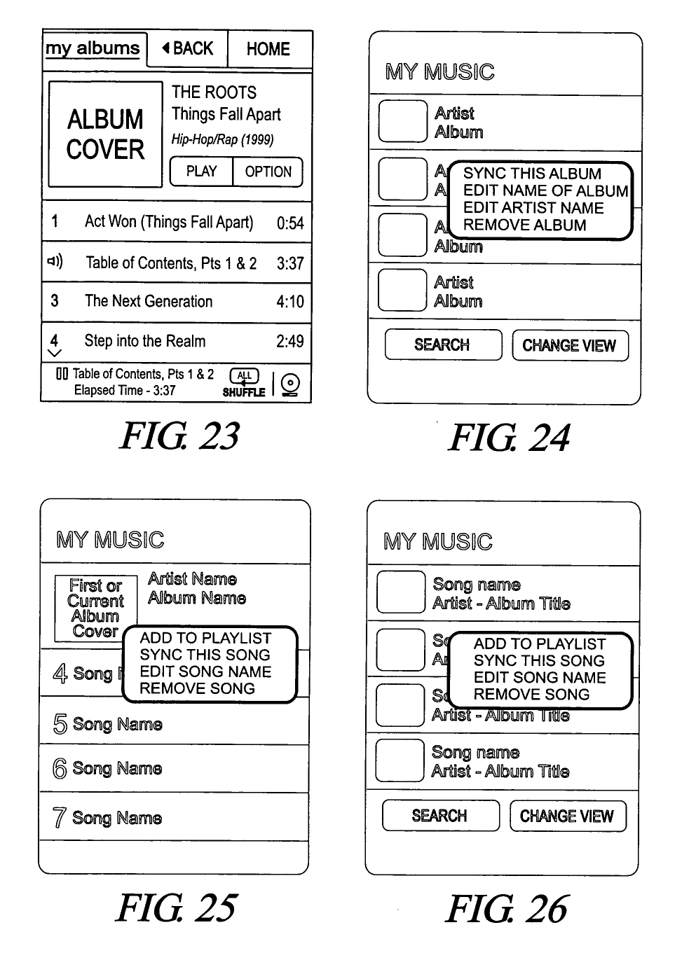

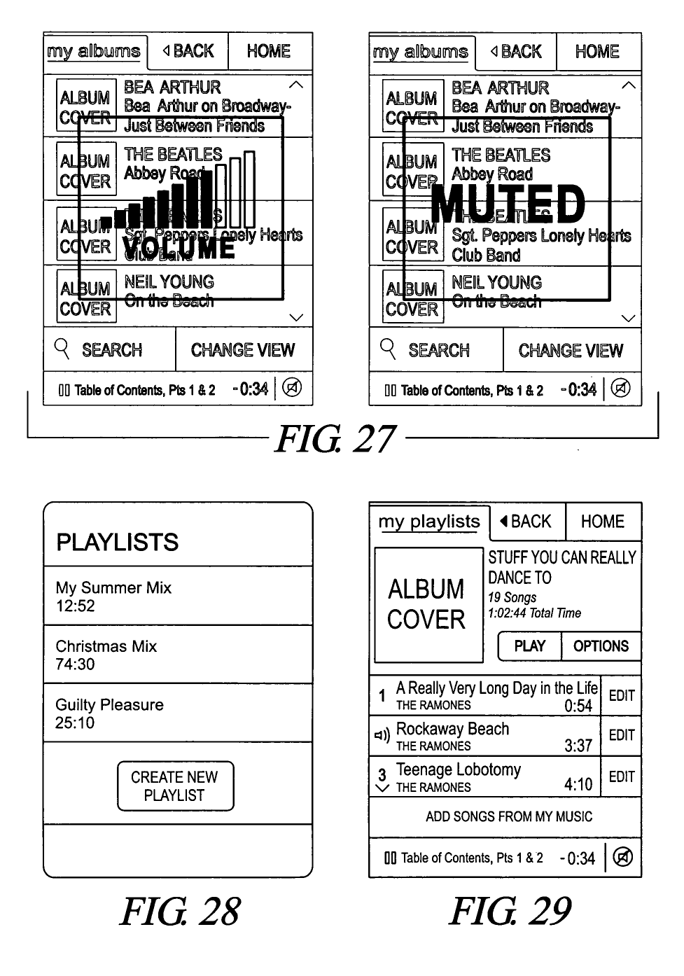

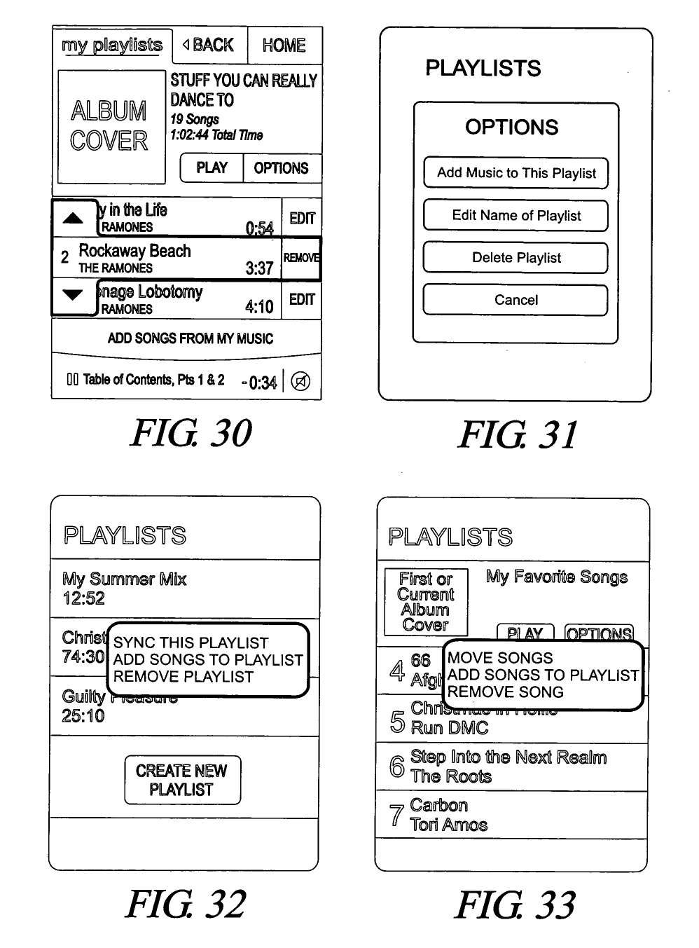

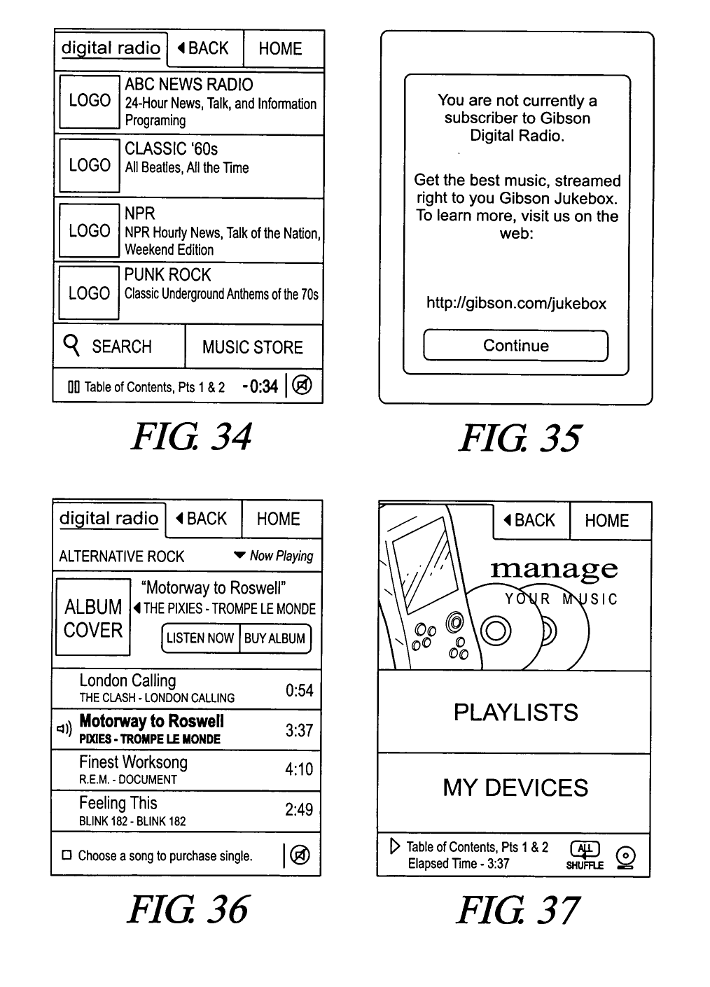

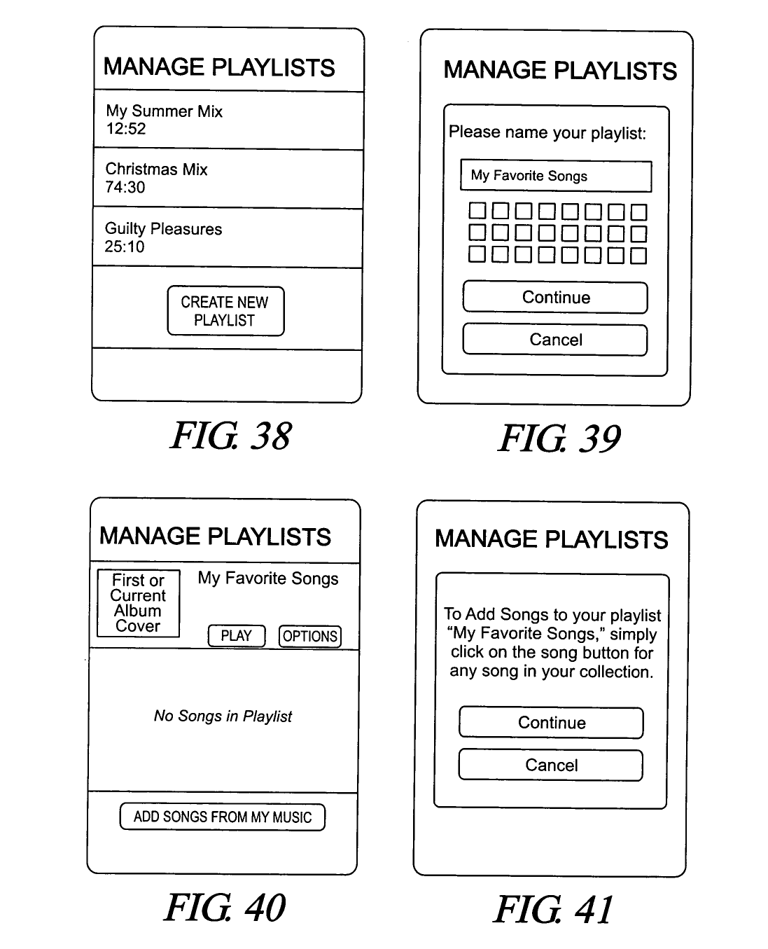

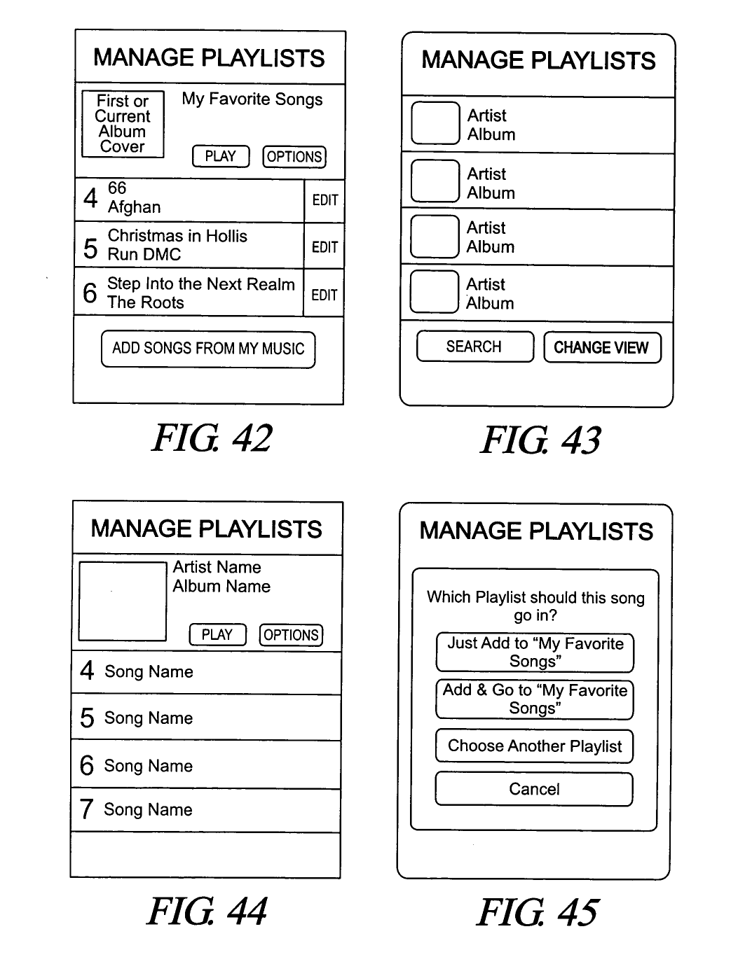

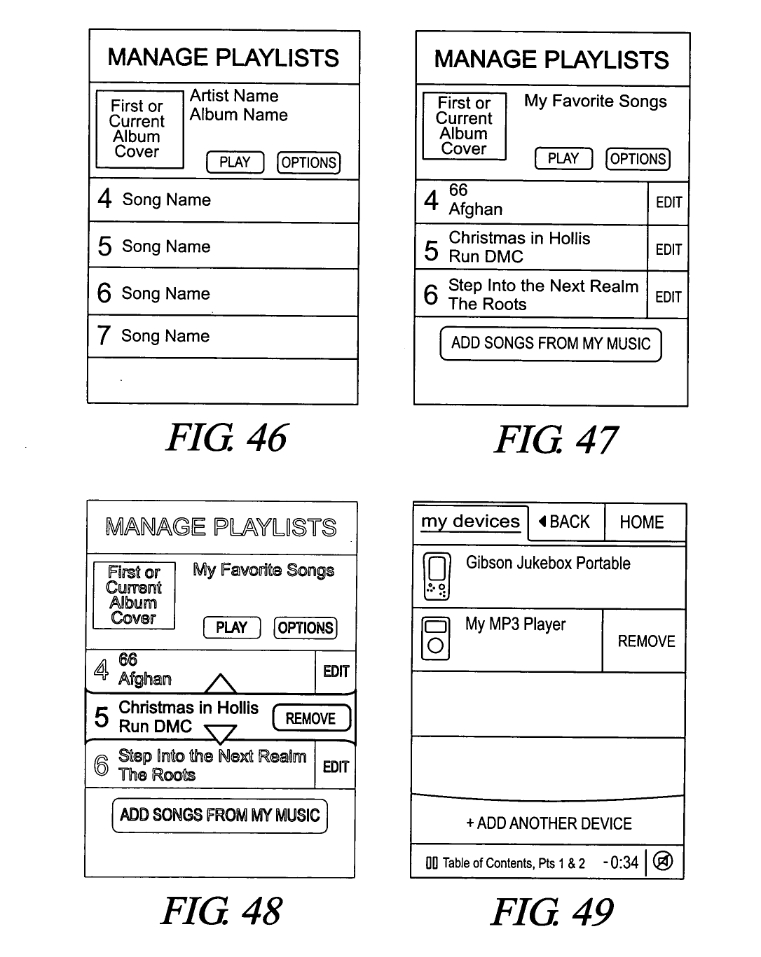

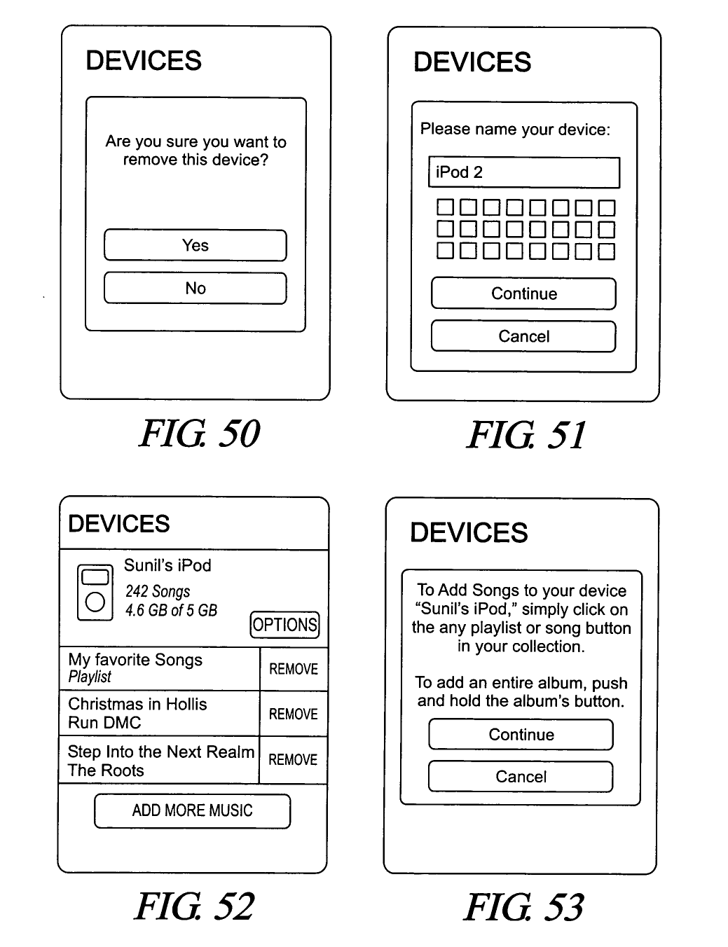

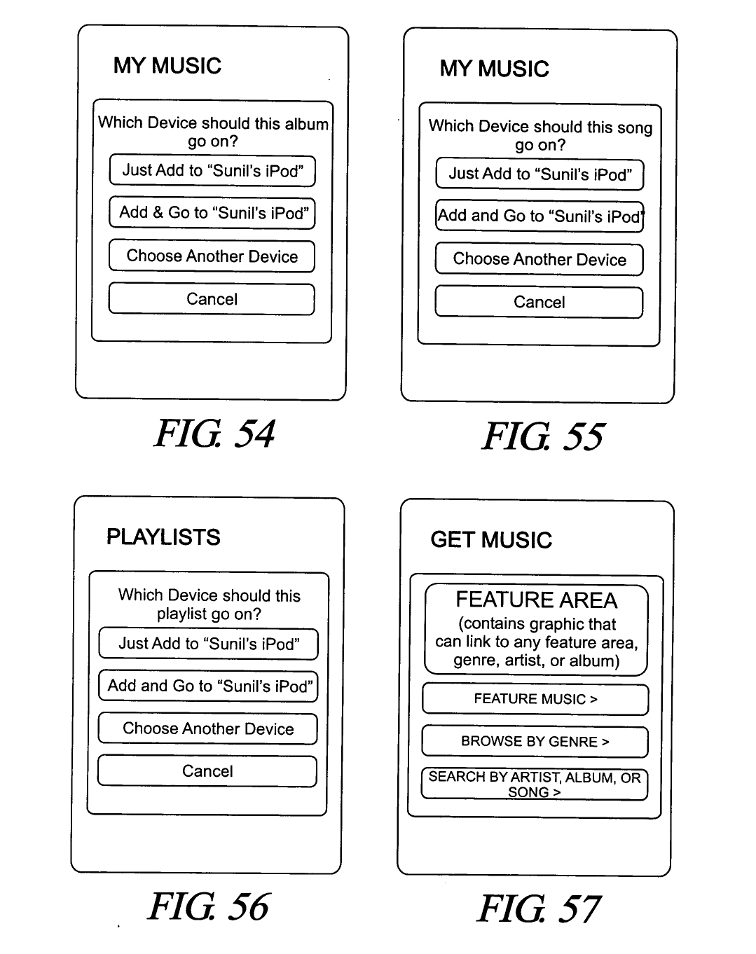

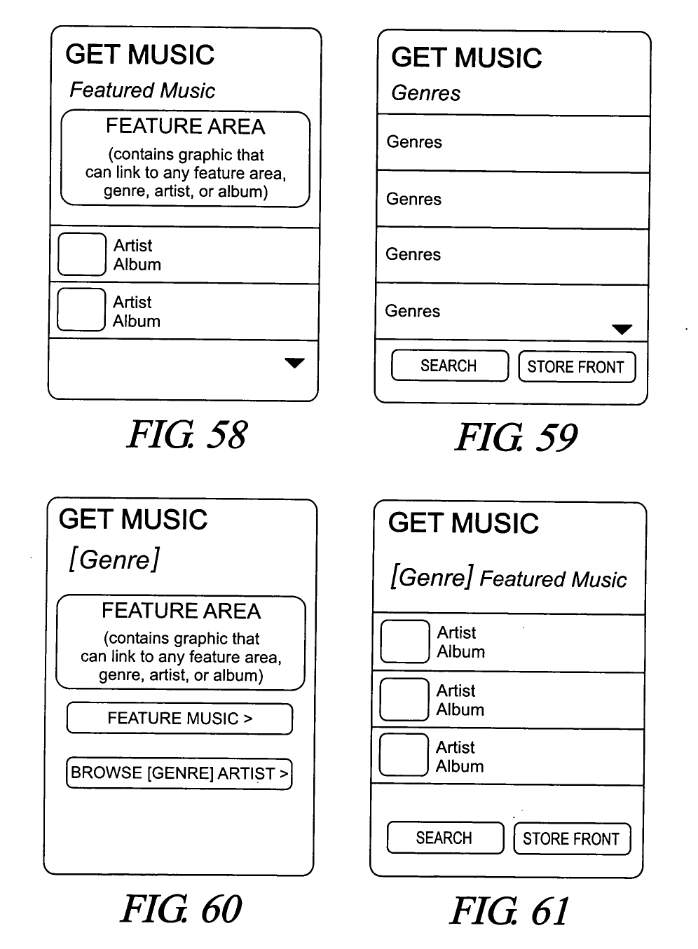

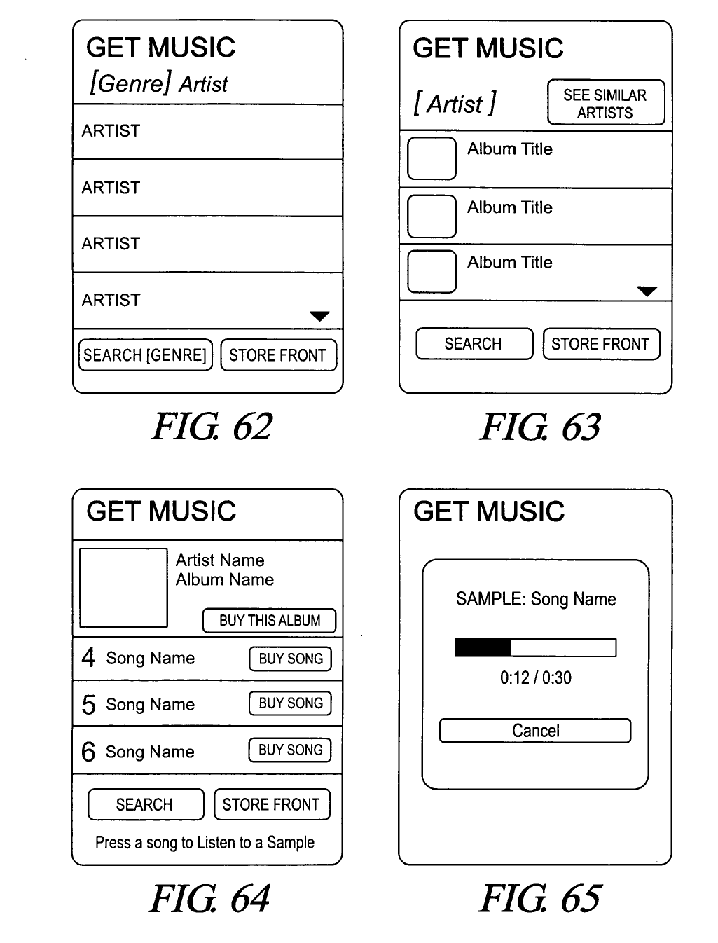

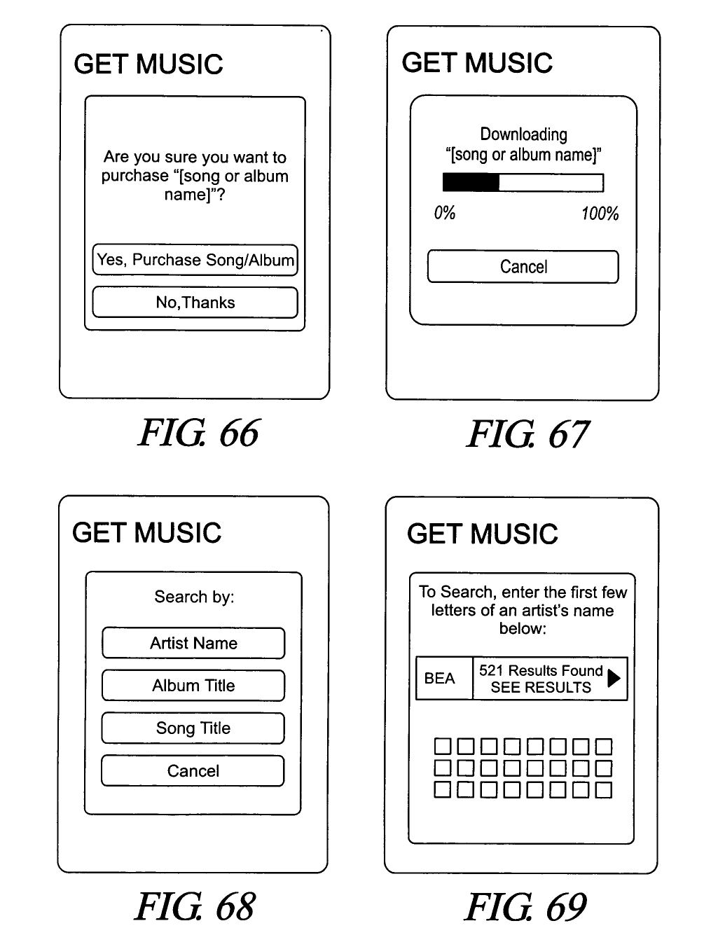

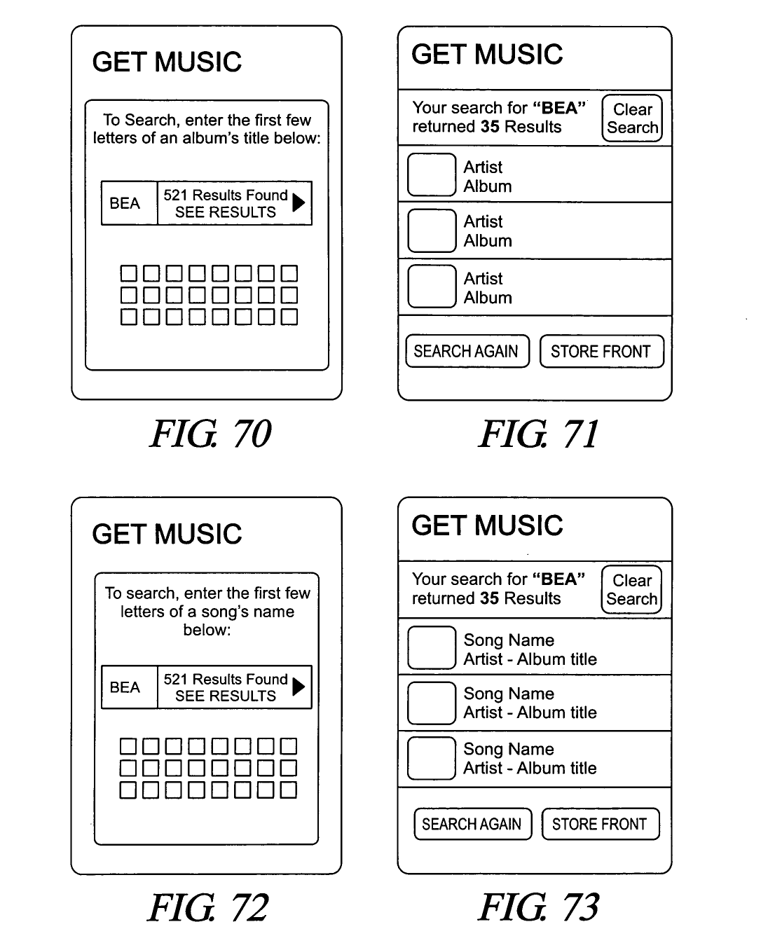

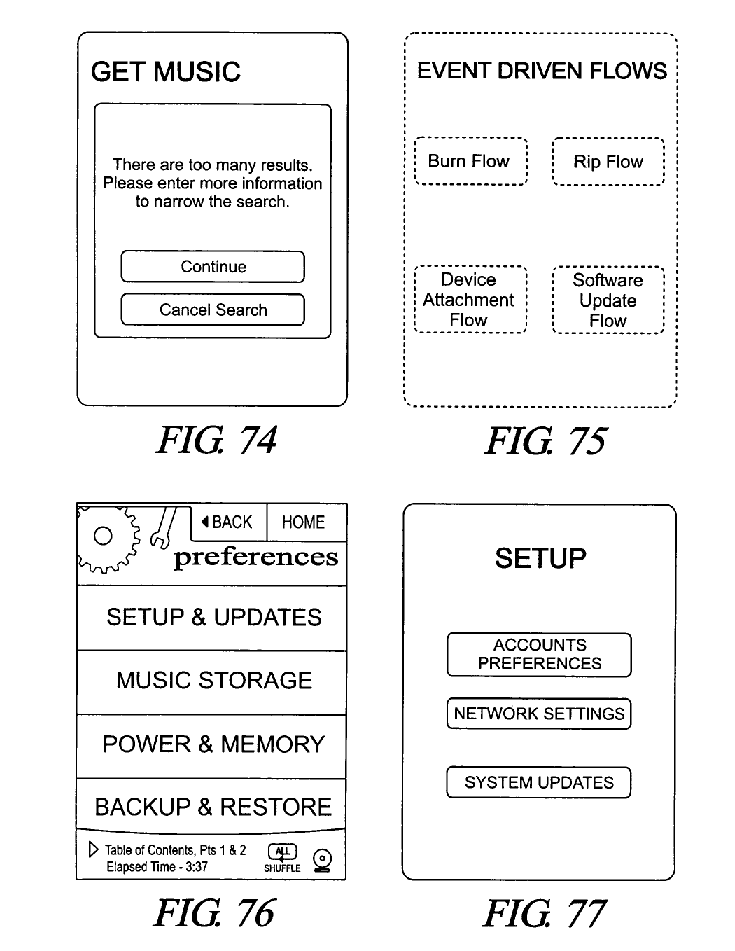

If a search generates too may results, the UI software 20 generates a screen indicating that fact (FIG. 74) and, if a search for an album title or song results in an exact match, the UI software 20 generates a “Purchase album or song” screen including the identified album or song. In a similar manner, if a search results in the identification of a specific artist, the UI software 20 generates a screen containing a listing of albums by the identified artist.

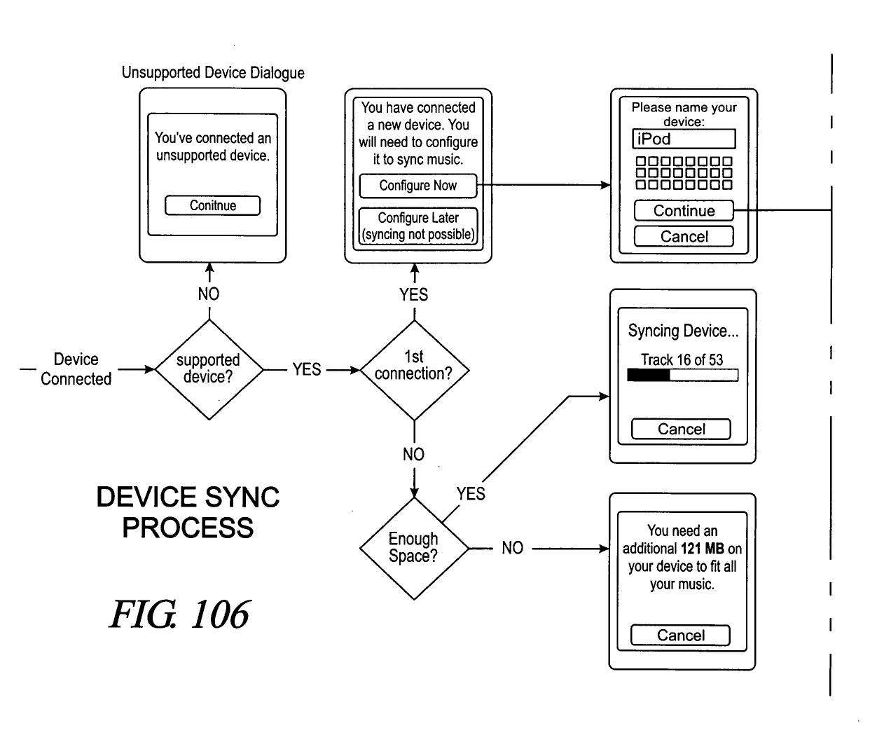

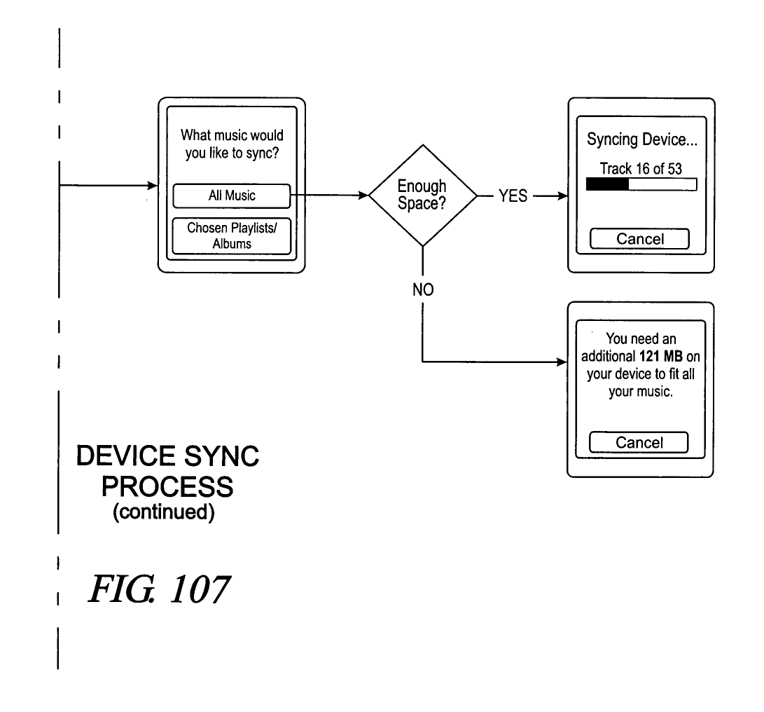

Referring to FIG. 75, the UI software 20 of the present invention automatically initiates several processes, referred to as event driven flows in FIG. 75, when certain events take place. When a user inserts a CD in the CD drive 26 (FIG. 1), the UI software 20 initiates a rip flow or a burn flow depending on whether the CD is a music CD or a blank CD. If the CD is blank, the UI software 20 initiates a burn flow. If the CD is a music CD containing music, the UI software 20 initiates a rip flow. Also, if an external device, such as the remote control unit 14, an iPod, or an MP3 player are connected to the combination recorder and player unit 12, the UI software 20 initiates a device attachment flow that attempts to synchronize the music information contained on the external device with the music information contained on the combination recorder and player unit 12 (see FIG. 94 and FIGS. 106-107), and periodically, the UI software 20 automatically initiates a software update flow that updates the UI software 20 and the combination recorder and player software 32 (FIG. 1) using information received from the music server 42.

When a CD is inserted into the CD drive 26 (FIG. 1), the UI software 20 evaluates the CD to determine if it can be played by the system, to determine if it contains music that can be imported into the system, or to determine if it can be written to by the system. If not, the UI software 20 generates and displays a screen alerting a user to that fact and prompting the user to eject the CD. This screen will appear over the last screen the UI software 20 was displaying before the CD was inserted.

If the CD is a blank CD, the UI software 20 will proceed according to the burn flow discussed in more detail below. If the CD is a music CD containing music, the UI software 20 will evaluate the CD to determine if it has already been imported into the combination recorder and player unit 12. If it is already stored on the combination recorder and player unit 12, the UI software 20 will generate a screen indicating that fact and including a “Go to album” button that a user can click on to pull up an “Album detail” screen showing the album stored in the combination recorder and player unit 12. If not, the UI software 20 will check the local CDDB 36 to determine if the CD is listed in that database.

If the CD is found in the local CDDB 36, the UI software 20 will check to make sure that there is only one listing for the CD in the CDDB 36. If that is true, the UI software 20 will use the information contained in that database, e.g., CD name, song names, song durations, etc. to display a “CD detail” screen containing a listing of the songs on the CD, as well as any graphics that might be associated with the CD and stored in the local graphics database 38. If there is more than one listing in the CDDB 36, the UI software 20 will generate a screen including a listing of the multiple records and prompting the user to select the appropriate record to use to display the “CD detail” screen. If the user is not sure which record to choose, or decides to cancel the ripping process for some other reason, he can do so at this time. Also, if the local graphics database 38 does not contain any graphics associated with the CD, the combination recorder and player unit 12 will attempt to locate the graphics on a remote graphics database using its Internet communication system 40 (FIG. 1). If graphics cannot be found in the local graphics database 38 or a remote graphics database, the UI software 20 will display the “CD detail” screen without any graphics.

If the CD is not listed in the local CDDB 36 and an Internet connection is not available to be used by the combination recorder and player unit 12 to access a remote CDDB on the Internet, the UI software 20 will generate a “Generic CD detail” screen that includes generic information regarding the CD, e.g., untitled CD, song 1, song 2, etc. If an Internet connection is available and a remote CDDB can be accessed by the combination recorder and player unit 12, the UI software 20 will check to make sure that there is only one listing for the CD on the remote CDDB database. If that is the case, the UI software 20 will use the information contained in that database, e.g., CD name, song names, song durations, etc. (also referred to as metadata) to display a “CD detail” screen containing a listing of the songs on the CD, as well as any graphics that might be associated with the CD and stored in the local graphics database 38. If there is more than one record, the UI software 20 will generate a screen prompting the user to select the correct record to be used by the system. This is true whether information regarding the CD is found on the local CDDB 36 or a remote CDDB.

A few seconds after the “CD detail” screen is displayed, the UI software 20 will generate and display a screen over the “CD detail” screen asking the user what he or she would like to do with the CD. The user can choose to play the CD, in which case the UI software 20 displays the “CD detail” screen and the user can select a song on the CD to be played, or to play and store the CD, in which case the UI software 20 displays a “popup” balloon over the “CD detail” screen indicating that the CD is being stored and playback begins. Note that playback in this case is performed using the ripped music stored on the combination recorder and player unit 12. After a predetermined amount of time, the “popup” will disappear and the “CD detail” screen will be displayed alone once again.

The user may also choose to simply store the CD. In this case, the UI software 20 displays a “popup” balloon indicating that the CD is being stored. After a predetermined amount of time, the “popup” disappears and the “CD detail” screen is shown once again. The lower portion of this screen includes a “Now Playing” area that includes an icon indicating that a rip is currently taking place. If the user chooses to simply play the CD, the “CD detail” screen displayed in this case also includes a rip icon so that any songs on the CD can be stored on the combination recorder and player unit 12 at a later time (see right screen shown in FIG. 90). The user may also choose to cancel the rip flow and, in this case, the “CD detail” screen will be displayed along with a rip icon so that the CD may be ripped at a later time.

If the CD is not ripped and is left in the combination recorder and player unit 12, a user is able to find the CD in the CD menu within the My music series of screens. The CD will appear slightly different from already imported CDs, both in terms of color and iconography, and, if the user proceeds to the “CD detail” screen, a rip icon will appear so that the user can initiate a rip at some time in the future.

If a blank CD is inserted into the combination recorder and player unit 12, the UI software 20 generates a screen asking the user what they would like to do with the CD. The user has three options. He or she can click on a “Go to My Music” button or “Go to Playlists” button and go to Album and Playlist detail screens to burn a song, album, or playlist to the CD. Alternatively, the user can click on a “Nothing right now” button.

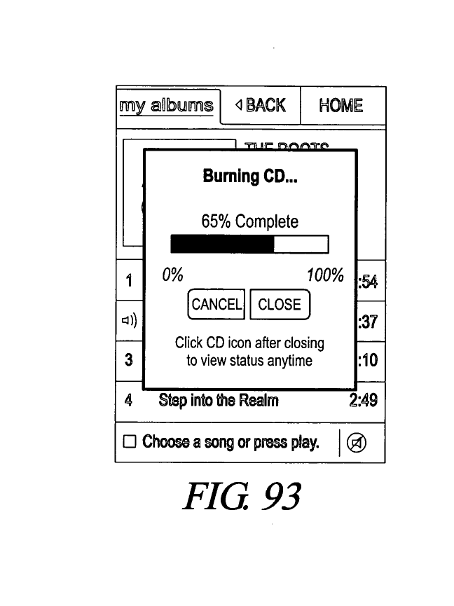

If the user clicks on the “Go to My Music” or the “Go to Playlists” button, each Album and Playlist detail screen will now have a burn icon indicating that a burn can be initiated (left screen shown in FIG. 90). If the user clicks on the burn icon, the checks to make sure that the CD is properly formatted. If not, the UI software 20 generates a screen indicating that fact and prompting the user to cancel the burn. If the CD is properly formatted, the system checks to see if the CD has enough memory to burn a music or MP3 CD. If not, the UI software 20 generates a screen indicating that there is not enough memory on the CD and prompting the user to reduce the number of songs, albums, or playlists to be burned. If the CD has enough memory to burn an MP3 CD but not a music CD, the UI software 20 generates a screen indicating that fact and prompting the user to indicate if an MP3 CD would be acceptable. If so, the system begins burning the MP3 CD and the UI software 20 generates a screen showing the progress of the burn (FIG. 93).

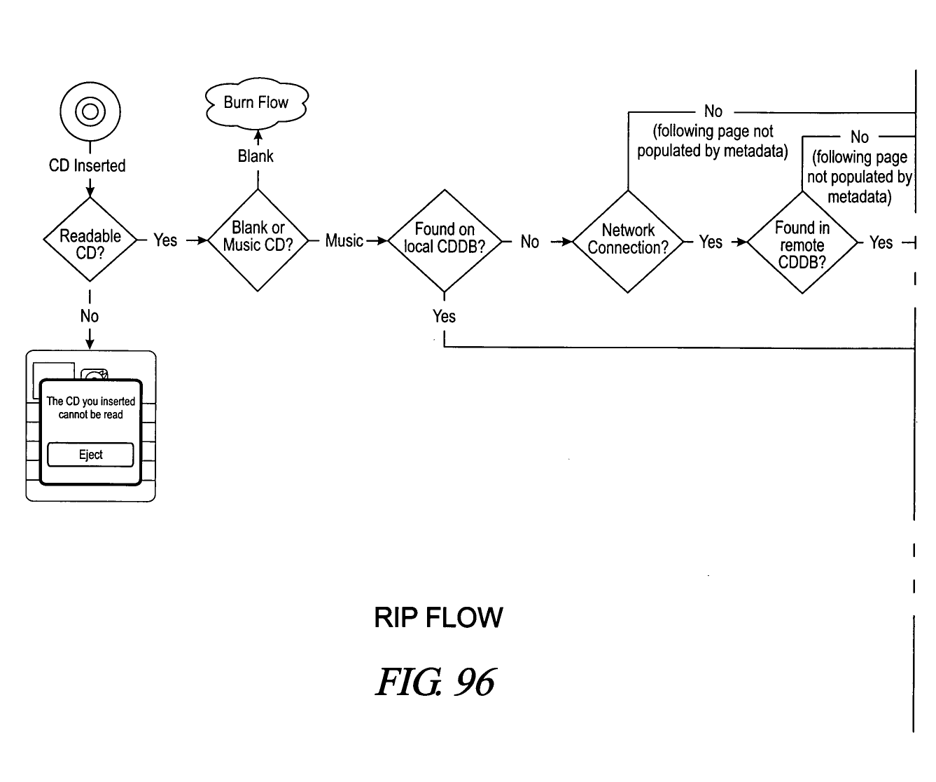

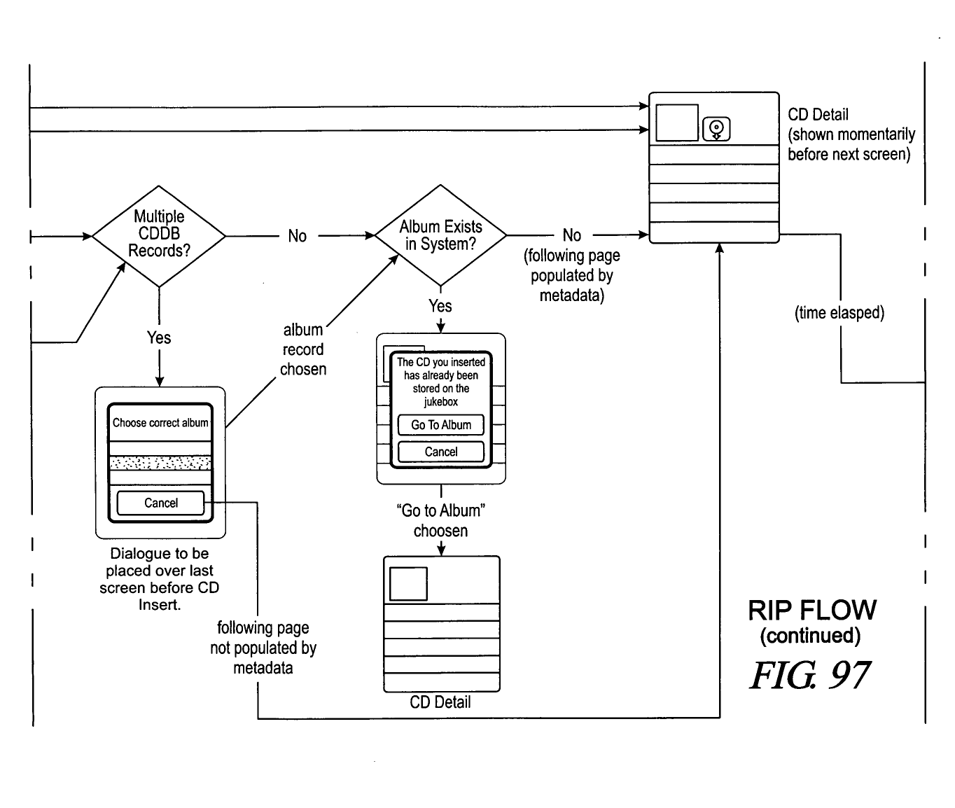

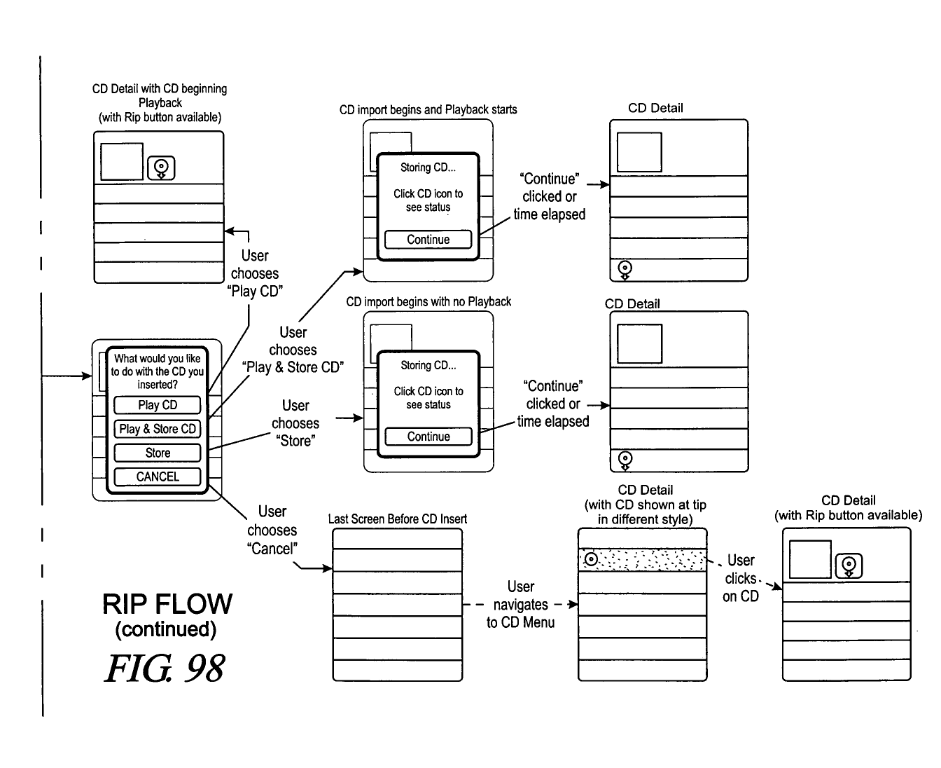

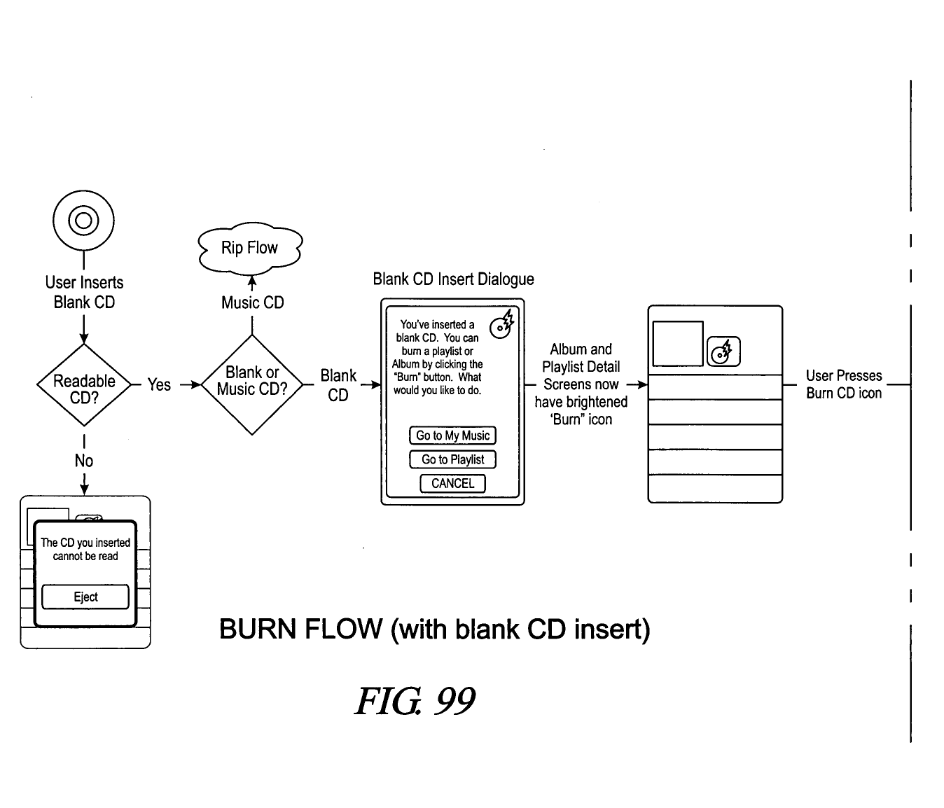

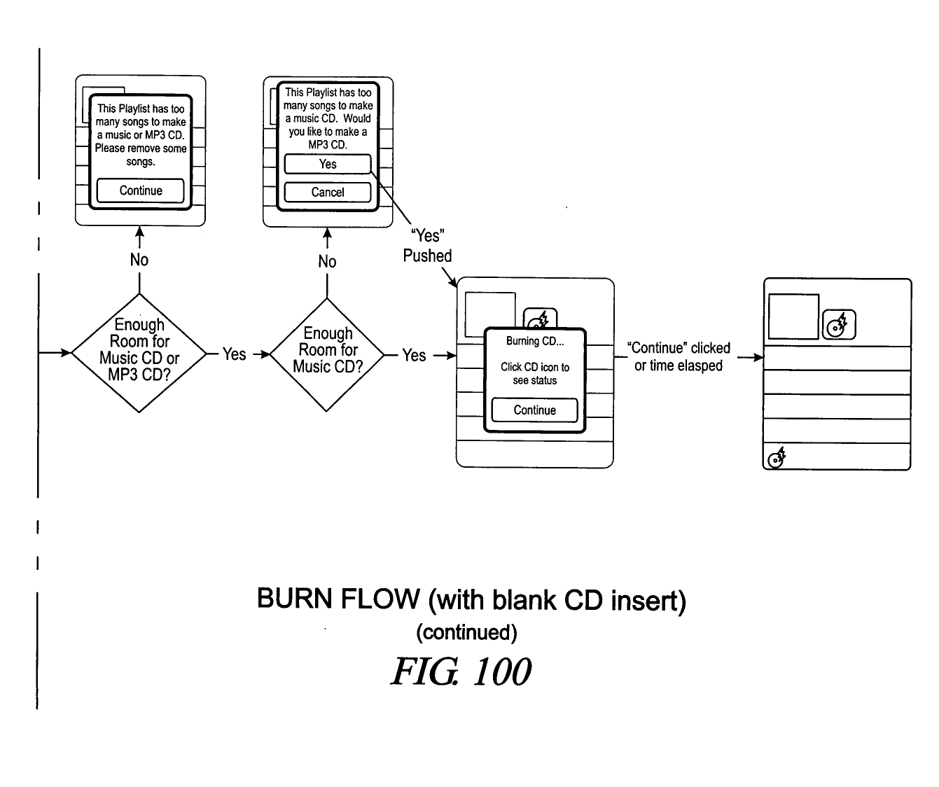

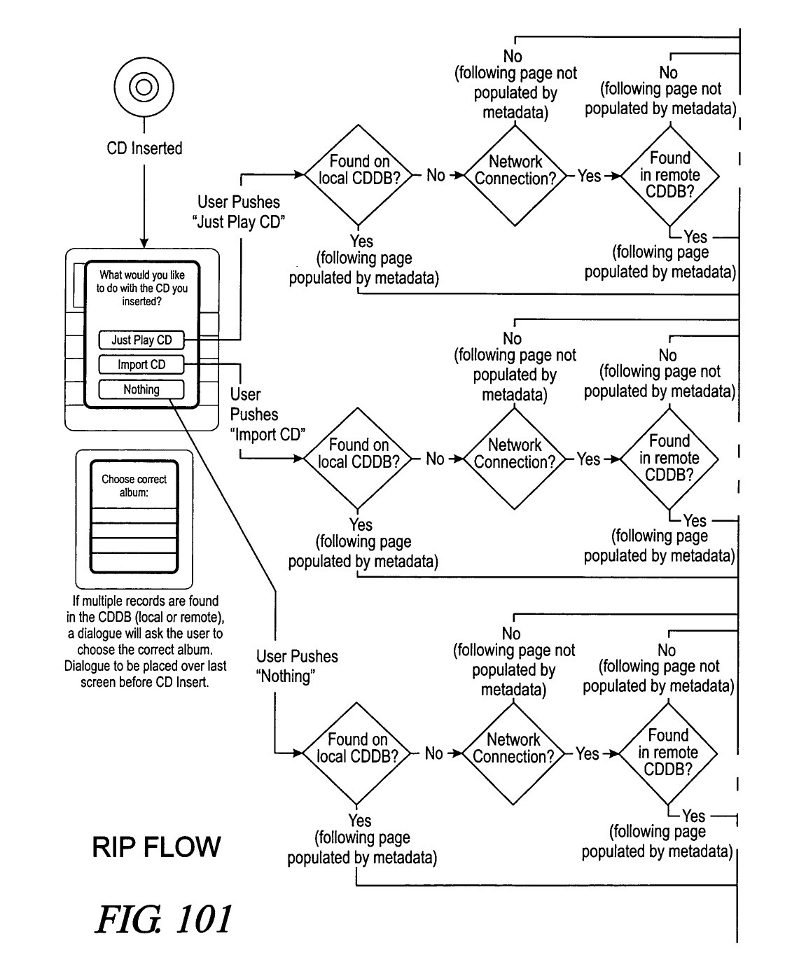

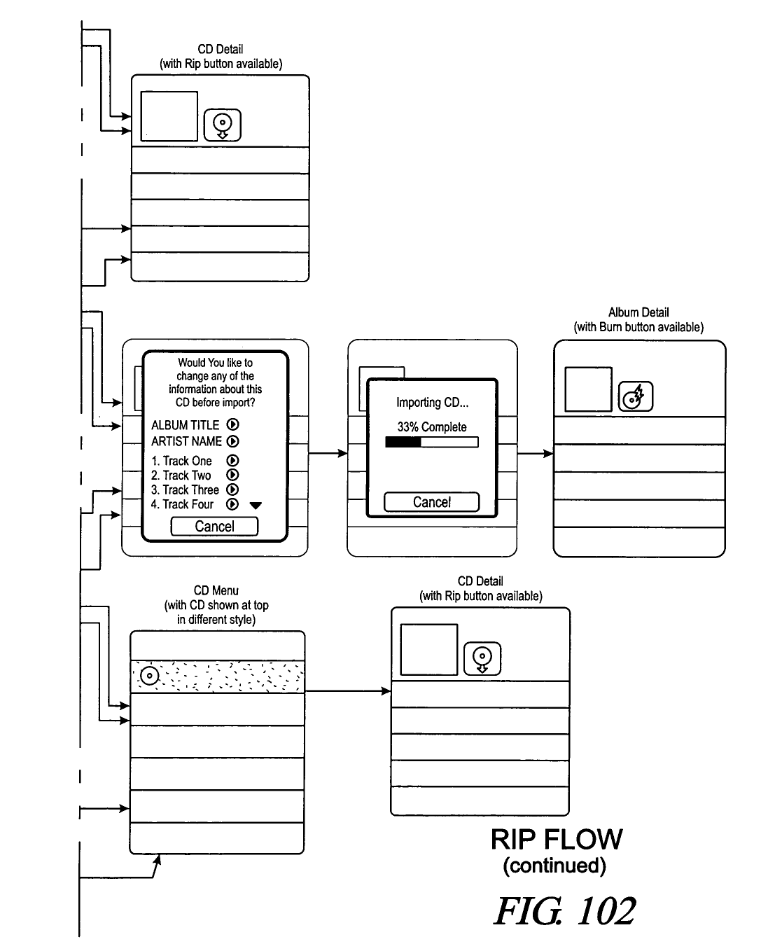

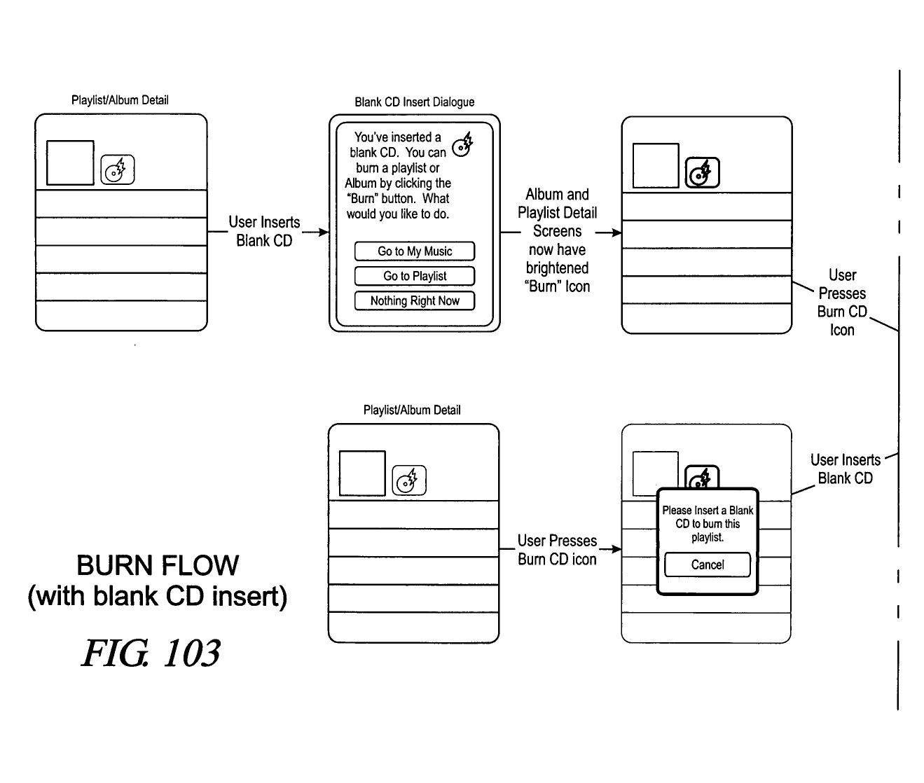

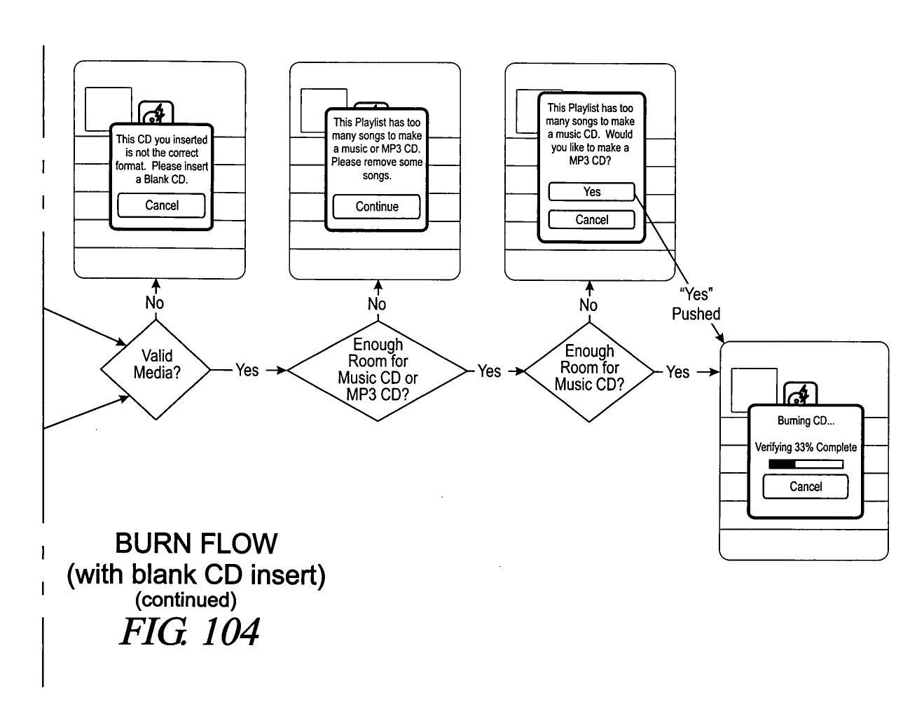

The overall rip flow discussed above is illustrated in FIGS. 96-98 and the overall burn flow discussed above is illustrated in FIGS. 99-100. Alternative rip and burn flows are also shown in FIGS. 101.

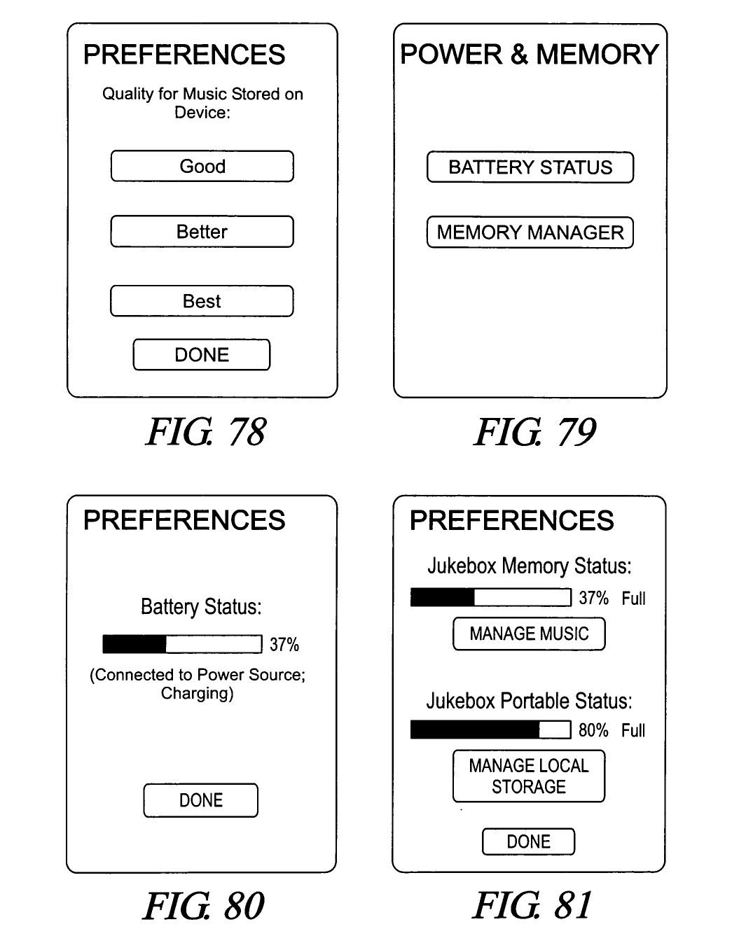

FIG. 76 is a screen generated and displayed by the UI software 20 that allows a user to adjust the setup and preferences for the system. If a user selects the “Setup & Updates” button, the UI software 20 generates and displays the screen shown in FIG. 77, which can be used by a user to set account preferences, network settings, and system updates. If a user selects the “Music Storage” button, the UI software 20 allows a user to set the quality of music stored on a device by generating the screen shown in FIG. 78. If a user clicks on the “Power & Memory” button, the UI software 20 allows a user to check the status of the battery in a device and status of memory in the combination recorder and player unit 12 and external devices, such as the remote control unit 14 by generating the screens shown in FIGS. 79-81.

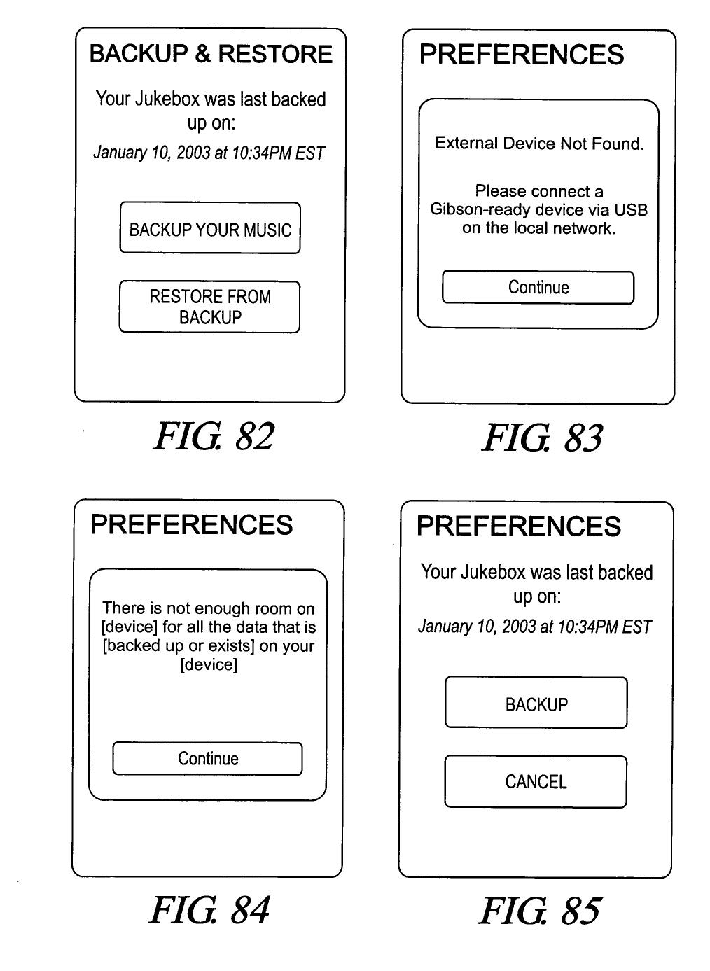

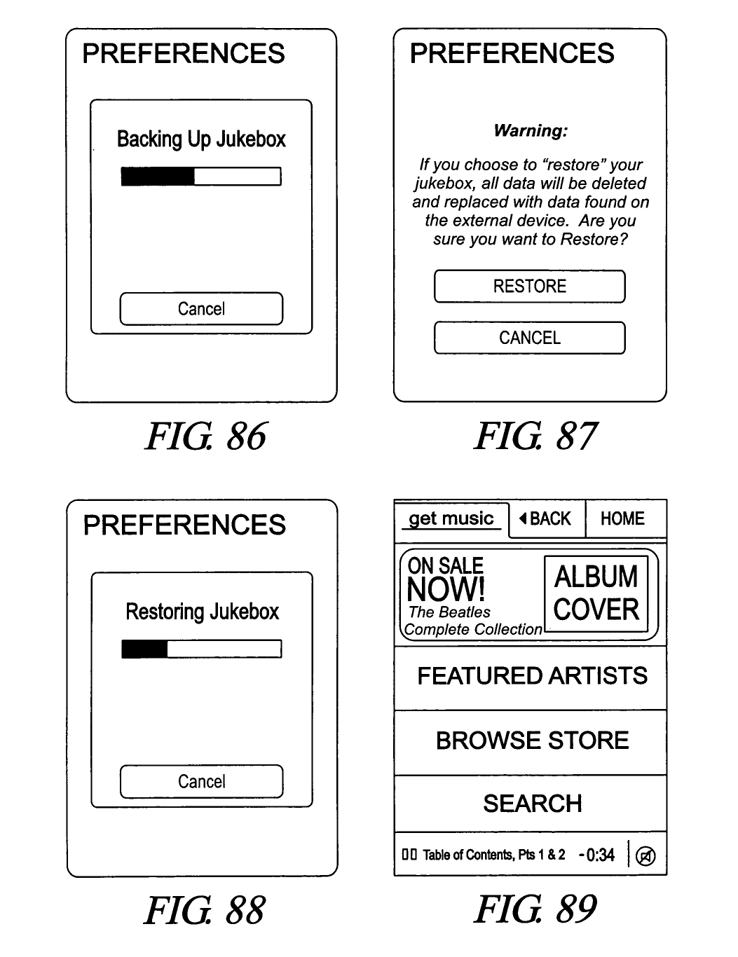

A user can backup or restore a previous backup by clicking on the “Backup & Restore” button and selecting the “Backup your music” or “Restore from backup” buttons shown in FIG. 82. If a user clicks on the “Backup your music” button, the UI software 20 checks to make sure that there is an external backup device connected, using either a USB connection or a network connection, to the combination recorder and player unit 12 and, if not, generates and displays an error screen indicating that fact. An example of that screen is shown in FIG. 83. If an external device is present, the UI software 20 checks to make sure that there is enough room on the external backup device to store all of the music from the combination recorder and player unit 12. If not, the UI software generates and displays the error screen shown in FIG. 84. If the backup device includes enough memory space to backup the combination recorder and player unit 12, the UI software 20 generates a screen (FIG. 85) that generates a screen indicating when the combination recorder and player unit 12 was last backed up. When a user clicks on the “Backup” button included in this screen, the UI software 20 begins backing up the combination recorder and player unit 12 and displays a status screen showing the progress of the backup (see FIG. 86).

If a user clicks on the “Restore from backup” button shown in FIG. 82, the UI software 20 checks to make sure an external device containing a backup is connected to the combination recorder and player unit 12 using a USB or network connection and to make sure that the combination recorder and player unit 12 has enough memory to hold the backup to be restored. If an external device is not connected, the UI software 20 generates the error screen shown in FIG. 83 and if there is not enough memory, the UI software 20 generates the error screen shown in FIG. 84. If an external device is connected and there is enough memory, the UI software 20 generates a warning screen that warns a user that restoring the backup will cause all data on the combination recorder and player unit 12 to be deleted and prompts the user to confirm that they want to proceed by clicking on a “Restore” button (FIG. 87). If the user clicks on the “Restore” button, the UI software 20 begins restoring the backup and displays the restore progress status screen shown in FIG. 88.

As explained in more detail in the '811 patent application discussed previously, the music server 42 (FIG. 1) is designed to provide access to 100 channels of digital radio content that is DMCA compliant and unlicensed by the record labels. The digital radio content is not available to systems that do not include the combination recorder and player unit 12 discussed in this and the previously mentioned co-pending patent applications. The digital data store included in the music server 42 allows users to purchase songs for $0.99 cents per song by charging that amount to a credit card. The songs may be downloaded in a variety of different formats, including Windows Media compressed data, AAC, OOGVOI, and real networks formats.

Thus, although there have been described particular embodiments of the present invention of a new User Interface for a Combination Recorder and Player System, it is not intended that such references be construed as limitations upon the scope of this invention except as set forth in the following claims.

1. A combination recorder and player system, comprising:
a combination recorder and player unit for storing, playing, and burning music CDs, for creating, storing, and playing music playlists, for exporting music to external devices, for accessing and playing digital radio channels available from a music server computer system, and for purchasing, downloading, and storing music from the music server computer system; and
a user interface for the combination recorder and player unit that allows a user to input commands that cause the combination recorder and player unit to store, play, and burn music CDs, to create, store, and play music playlists, to export music to external devices, to access and play digital radio channels available from the music server computer system, and to purchase, download, and store music from the music server computer system.

2. The system of claim 1, wherein the combination recorder and player unit includes a CD drive for playing and burning music CDs, a music database for storing music CDs, music playlists, and music from the music server computer system, a recorder/player communication system for exporting music to external devices, an Internet communication system for accessing digital radio channels and downloading music from the music server computer system, and a recorder/player computer system and software for causing the CD drive to play and burn music CDs and for causing the combination recorder and player unit to store music CDs, music playlists, and music from the music server computer system on the music database, to create and play music playlists, to export music to external devices using the recorder/player communication system, to play digital radio channels from the music server computer system, and to purchase and download music from the music server computer system.

3. The system of claim 1, wherein the user interface is operable to allow a user to input commands that cause the user interface to display and scroll through music listings of music stored on the combination recorder and player unit, to display and scroll through a listing of playlists stored on the combination recorder and player unit, and to display and scroll through a channel listing of digital radio channels available from the music server computer system.

4. The system of claim 1, wherein the user interface is operable to allow a user to input commands that cause the user interface to display and scroll through an album listing of albums stored on the combination recorder and player unit, to display and scroll through a song listing of songs stored on the combination recorder and player unit, and to switch back and forth from the album listing to the song listing.

5. The system of claim 4, wherein the album listing of albums displayed by the user interface includes a picture of the album cover associated with each album included in the album listing, the name of each album included in the album listing, and the name of the artist who authored each album included in the album listing.

6. The system of claim 5, wherein the user interface is operable to allow a user to input commands that cause the user interface to display detailed album information regarding each album including in the album listing, the detailed album information for each album including a picture of the album cover associated with the album, the name of the album, the name of the artist who authored the album, the genre associated with the album, the date that the album was first released, the name of each song included on the album, and the duration of each song included on the album.

7. The system of claim 6, wherein the user interface is operable to allow a user to input commands that cause the user interface to edit the name of an album included in the album listing, to edit an artist name associated with an album included in the album listing, and to remove an album from the combination recorder and player unit.

8. The system of claim 1, wherein the user interface is operable to allow a user to input commands that cause the user interface to display a playlist listing of playlists stored on the combination recorder and player unit, the playlist listing including the name of each playlist included in the playlist listing and the duration of each playlist included in the playlist listing.

9. The system of claim 8, wherein the user interface is operable to allow a user to input commands that cause the user interface to display detailed playlist information regarding each playlist including in the playlist listing, the detailed playlist information for each playlist including a picture of an album cover associated with an album included in the playlist, the name of the playlist, the number of songs included in the playlist, the total playing time of the playlist, and a listing of the songs included in the playlist.

10. The system of claim 1, wherein the user interface is operable to allow a user to input commands that cause the user interface to create playlists, to add music to a playlist included in a playlist listing, to edit the name of a playlist included in the playlist listing, and to remove a playlist from the combination recorder and player unit.

11. The system of claim 1, wherein the user interface is operable to allow a user to input commands that cause the user interface to display a listing of songs stored on the combination recorder and player unit interface, the song listing including a picture of an album cover and the name of an album associated with each song included in the song listing, the name of each song included in the song listing, and the name of the artist who recorded each song included in the song listing.

12. The system of claim 11, wherein the user interface is operable to allow a user to input commands that cause the user interface to add a song included in the song listing to a music playlist, to edit the name of a song included in the song listing, and to remove a song from the combination recorder and player unit.

13. The system of claim 1, wherein the user interface is operable to allow a user to input commands that cause the user interface to perform searches of music stored on the combination recorder and player unit based on artist name, album title, and genre and to display the results of those searches.

14. The system of claim 1, wherein the user interface is operable to allow a user to input commands that cause the user interface to synchronize music stored on the combination recorder and player unit with music stored on external devices.

15. The system of claim 1, wherein the user interface is operable to allow a user to input commands that cause the user interface to display a channel listing of digital radio channels available from the music server computer system, the channel listing including a picture of an album cover or other information associated with each digital radio channel included in the channel listing, the name of each digital radio channel included in the channel listing, and a description of the music or other information available from each digital radio channel included in the channel listing.

16. The system of claim 15, wherein the user interface is operable to allow a user to input commands that cause the user interface to display detailed channel information regarding each digital radio channel including in the channel listing, the detailed playlist information for each digital radio channel including a picture of an album cover or other associated with the digital radio channel, the name of the digital radio channel, the name of a song or other information that is currently being played on the digital radio channel, and a listing of songs or other information available from the digital radio channel.

17. The system of claim 1, wherein the user interface is operable to allow a user to input commands that cause the user interface to display and scroll through a featured music listing of featured music available for sale and downloading from the music server computer system and to display and scroll through a genre listing of music available for sale and downloading from the music server computer system.

18. The system of claim 1, wherein the user interface is operable to allow a user to input commands that cause the user interface to perform searches of music available for sale and downloading from the music server computer system based on artist name, album title, and song title and to display the results of those searches.

19. A user interface, comprising:
a touch sensitive display;
a communication system;
a computer system connected to the touch sensitive display and the communication system; and
user interface software operable to cause the computer system to receive music information regarding music stored on a combination recorder and player unit associated with the user interface using the communication system, to display a series of screens containing the music information to a user using the touch sensitive display, to allow the user to input user commands identifying functions that the user would like the combination recorder and player unit to perform using the touch sensitive display and the series of screens, and, in response to the user commands, to generate and transmit control signals that cause the combination recorder and player unit to perform the identified functions using the communication system.

20. The user interface of claim 19, wherein the user interface software is operable to cause the computer system to allow the user to input user commands that cause the combination recorder and player unit to store, play, and burn music CDs, to create, store, and play music playlists, to export music to external devices, to access and play digital radio channels available from the music server computer system, and to purchase, download, and store music from a music server computer system associated with the combination recorder and player unit.

21. The system of claim 19, wherein the user interface software is operable to cause the computer system to allow the user to input user commands that cause the computer system to display and scroll through music listings of music stored on the combination recorder and player unit, to display and scroll through a playlist listings of playlists stored on the combination recorder and player unit, and to display and scroll through a channel listing of digital radio channels available from the music server computer system.

22. The system of claim 19, wherein the user interface is operable to cause the computer system to allow the user to input user commands that cause the computer system to display and scroll through an album listing of albums stored on the combination recorder and player unit, to display and scroll through a song listing of songs stored on the combination recorder and player unit, and to switch back and forth from the album listing to the song listing.

23. The system of claim 22, wherein the album listing of albums displayed by the computer system includes a picture of the album cover associated with each album included in the album listing, the name of each album included in the album listing, and the name of the artist who authored each album included in the album listing.

24. The system of claim 23, wherein the user interface software is operable to cause the computer system to allow the user to input user commands that cause the computer system to display detailed album information regarding each album including in the album listing, the detailed album information for each album including a picture of the album cover associated with the album, the name of the album, the name of the artist who authored the album, the genre associated with the album, the date that the album was first released, the name of each song included on the album, and the duration of each song included on the album.

25. The system of claim 24, wherein the user interface software is operable to cause the computer system to allow the user to input user commands that cause the computer system to edit the name of an album included in the album listing, to edit an artist name associated with an album included in the album listing, and to remove an album from the combination recorder and player unit.

26. The system of claim 19, wherein the user interface software is operable to cause the computer system to allow the user to input commands that cause the computer system to display a playlist listing of playlists stored on the combination recorder and player unit, the playlist listing including the name of each playlist included in the playlist listing and the duration of each playlist included in the playlist listing.

27. The system of claim 26, wherein the user interface software is operable to cause the computer system to allow the user to input commands that cause the computer system to display detailed playlist information regarding each playlist including in the playlist listing, the detailed playlist information for each playlist including a picture of an album cover associated with an album included in the playlist, the name of the playlist, the number of songs included in the playlist, the total playing time of the playlist, and a listing of the songs included in the playlist.

28. The system of claim 19, wherein the user interface software is operable to cause the computer system to allow the user to input commands that cause the computer system to create playlists, to add music to a playlist included in a playlist listing, to edit the name of a playlist included in the playlist listing, and to remove a playlist from the combination recorder and player unit.

29. The system of claim 19, wherein the user interface software is operable to cause the computer system to allow the user to input commands that cause the computer system to display a song listing of songs stored on the combination recorder and player unit interface, the song listing including a picture of an album cover and the name of an album associated with each song included in the song listing, the name of each song included in the song listing, and the name of the artist who authored each song included in the song listing.

30. The system of claim 29, wherein the user interface software is operable to cause the computer system to allow the user to input commands that cause the computer system to add a song included in the song listing to a music playlist, to edit the name of a song included in the song listing, and to remove a song from the combination recorder and player unit.

31. The system of claim 19, wherein the user interface software is operable to cause the computer system allow the user to input commands that cause the computer system to perform searches of music stored on the combination recorder and player unit based on artist name, album title, and genre and to display the results of those searches.

32. The system of claim 19, wherein the user interface software is operable to cause the computer system to allow the user to input commands that cause the computer system to synchronize music stored on the combination recorder and player unit with music stored on external devices.

33. The system of claim 19, wherein the user interface software is operable to cause the computer system to allow the user to input commands that cause the computer system to display a channel listing of digital radio channels available from the music server computer system, the channel listing including a picture of an album cover or other information associated with each digital radio channel included in the channel listing, the name of each digital radio channel included in the channel listing, and a description of the music or other information available from each digital radio channel included in the channel listing.

34. The system of claim 33, wherein the user interface software is operable to cause the computer system to allow the user to input commands that cause the computer system to display detailed channel information regarding each digital radio channel including in the channel listing, the detailed playlist information for each digital radio channel including a picture of an album cover or other associated with the digital radio channel, the name of the digital radio channel, the name of a song or other information that is currently being played on the digital radio channel, and a listing of songs or other information available from the digital radio channel.

35. The system of claim 19, wherein the user interface software is operable to cause the computer system to allow the user to input commands that cause the computer system to perform searches of digital radio channels available from the music server computer system based on artist name, album title, and genre and to display the results of those searches.

36. The system of claim 19, wherein the user interface software is operable to cause the computer system to allow the user to input commands that cause the computer system to display and scroll through a featured music listing of featured music available for sale and downloading from the music server computer system and to display and scroll through a genre listing of music available for sale and downloading from the music server computer system.

37. The system of claim 19, wherein the user interface software is operable to cause the computer system to allow the user to input commands that cause the computer system to perform searches of music available for sale and downloading from the music server computer system based on artist name, album title, and song title and to display the results of those searches.
